(19) United States
(12) Patent Application Publication
(10) Pub. No.: US 2026/0018872 A1
(43) Pub. Date: Jan. 15, 2026

(54) WIRE MANAGEMENT

(71) Applicant: Unirac, Inc., Albuquerque, NM (US)

(72) Inventor: Casey Ottesen, Albuquerque, NM (US)

(73) Assignee: Unirac, Inc., Albuquerque, NM (US)

(21) Appl. No.: 18/769,217

(22) Filed: Jul. 10, 2024

(51) Int. Cl. H02G 3/04; F16L 3/13

(52) U.S. Cl. CPC H02G 3/0456; F16L 3/13

(57) ABSTRACT

A wire management clip includes a retention body, a friction channel formed on and extending from the retention body, and a mounting channel formed on the retention body.

### TECHNICAL FIELD

The present disclosure relates generally to wire management systems and devices. Specifically, the present disclosure relates to systems and methods for managing wires associated with modules for use in solar panel arrays.

### BACKGROUND

Photovoltaic (PV) cells may include any electronic device that converts the energy of light directly into electricity by means of the photovoltaic effect. A collection of individual PV cells may form the electrical building blocks of photovoltaic modules that may be colloquially referred to as “solar panels.” Utilization of PV cells within solar panels is becoming ubiquitous throughout residential, commercial, and governmental properties as a means to obtain free and renewable energy through the production of direct current (DC) electricity. These solar panels may be affixed to or mounted on a building such as a roof of a home or other building or other mounting surfaces. In order to avoid the potential for any damage occurring to a mounting system or mounting surfaces, or structure on which the system is located (e.g., damage from fires resulting in damage to wiring within the solar panel(s)), the solar panels and associated cabling, wiring, electrical modules, electrical components, frames, and mounting devices may be designed to be easily installed and minimally invasive or secure and safe and not destructive to the mounting surfaces and associated structure.

Among the cabling, wiring, electrical modules, framing, and mounting devices associated with the installation of solar panel systems, the cabling, wiring, and electrical modules may create a potential electrical hazard if these elements are not properly secured and organized within the solar panel systems. For example, insulation on loose wires or cables may potentially become worn or scraped by abrasion or chafing causing exposure of an electrical conductor, resulting in an electrical short of the electrical systems of the solar panel systems.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a wire management clip, according to an example of the principles described herein.

FIG. 2 illustrates the wire management clip of FIG. 1 in use in connection with a module and a frame with first wiring of the module being retained in a retention body of the wire management clip, according to an example of the principles described herein.

FIG. 3 illustrates the wire management clip of FIG. 1 in use in connection with the module and the frame with second wiring of the module being retained in friction channels of the wire management clip, according to an example of the principles described herein.

FIG. 4 illustrates the wire management clip of FIG. 1 in use in connection with the module and the frame with slack of the second wiring being taken up in a friction channel of the wire management clip, according to an example of the principles described herein.

FIG. 5 illustrates a wire management clip, according to an example of the principles described herein.

FIG. 6 illustrates a wire management clip, according to an example of the principles described herein.

FIG. 7 illustrates the wire management clip of FIG. 6 including a wire engaged therewith, according to an example of the principles described herein.

FIG. 8 illustrates a wire management clip including a wire engaged therewith, according to an example of the principles described herein.

FIG. 9 illustrates a wire management clip, according to an example of the principles described herein.

FIG. 10 illustrates the wire management clip of FIG. 9 including a wire engaged therewith, according to an example of the principles described herein.

FIG. 11 illustrates a wire management clip, according to an example of the principles described herein.

FIG. 12 illustrates a wire management clip, according to an example of the principles described herein.

FIG. 13 illustrates a wire management assembly including the wire management clip of FIG. 12 and an articulating support in a disengaged state with the wire management clip, according to an example of the principles described herein.

FIG. 14 illustrates the wire management assembly of FIG. 13 including the articulating support in an engaged state with the wire management clip, according to an example of the principles described herein.

FIG. 15 illustrates the wire management assembly of FIG. 13 in the engaged state and coupled to a frame, according to an example of the principles described herein.

FIG. 16 illustrates a perspective view of a wire management clip, according to an example of the principles described herein.

FIG. 17 illustrates a side view of the wire management clip of FIG. 16, according to an example of the principles described herein.

FIG. 18 illustrates the wire management clip of FIG. 16 with wires engaged therewith and coupled to a frame, according to an example of the principles described herein.

### OVERVIEW

This disclosure describes systems and methods including clips for wire or cable management within solar panels and systems or arrays of solar panels. As mentioned above, loose wires or cables may potentially cause electrical shorts or unintended wearing of the electrical systems of the solar panels and systems or arrays of solar panels. Therefore, the systems and methods including clips for wire or cable management may ensure that the wires or cables are properly secured and protected from abrasion, chafing, scraping, weather, sunlight, heat, cold or other elements.

In an embodiment, the clips described herein may secure wires or cables within a single solar panel or wires or cables that extend between multiple solar panels within an array or system of solar panels. Thus, examples described herein provide a wire management clip. In an embodiment, the wire management clip may include a retention body, a friction channel formed on and extending from the retention body, and a mounting channel formed on the retention body. As used in the present specification and in the appended claims, the terms “cable” or “wire” is meant to be understood broadly as any length of material configured to bear mechanical loads, carry electric current, and/or send telecommunication signals between two terminals.

### EXAMPLE EMBODIMENTS

This disclosure describes wire management clips used to secure and protect wires or cables that extend within a solar panel and to and from an array of solar panels. Protection of these wire or cables reduces the possibility of a failure of the wires or cables or damage to the wires or cables. Still further, the wire management clips ensure that the surrounding elements such as the substrate on which the solar panels are mounted are protected from any damage that may occur from the wires or cables not being secured.

Certain implementations and embodiments of the disclosure are described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

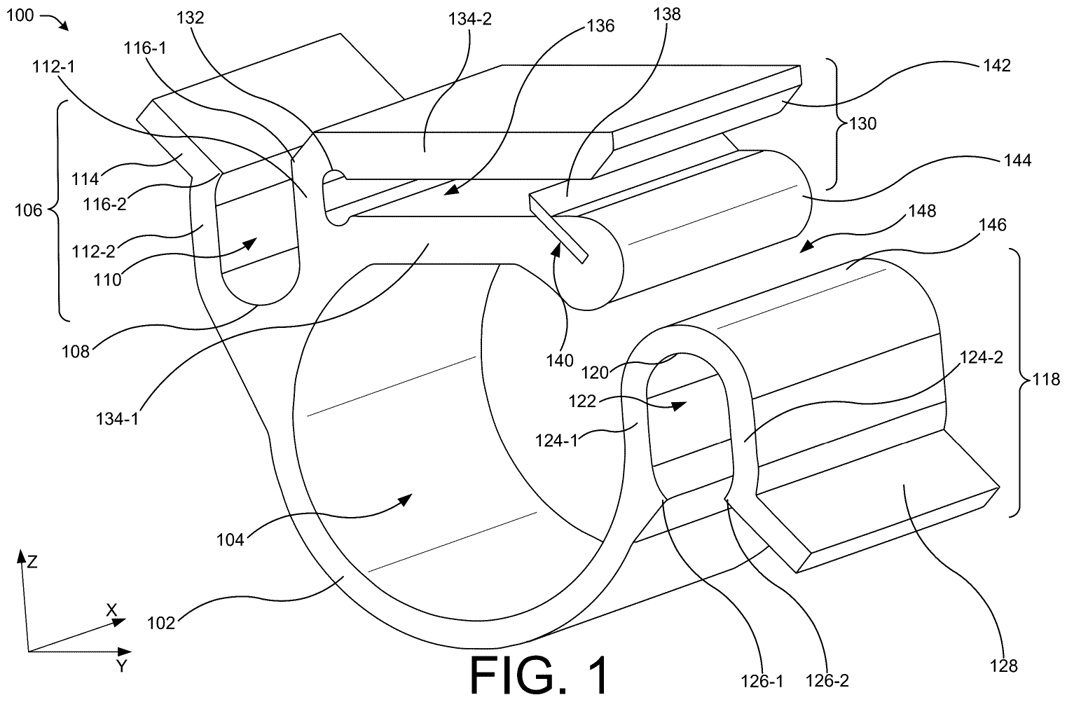

FIG. 1 illustrates a wire management clip 100, according to an example of the principles described herein. The wire management clip 100 and other wire management clips described herein may be used in connection with the managing cables and wires included with a solar panel and/or within, for example, an array of solar panels. The cables and wires may be simply referred to herein as wires or wiring. The solar panels within an array of solar panels may each include an electrical module electrically coupled to individual solar panels such as a module-level-power or electronic device such as a microinverter, an electrical junction box, a power optimizer, or similar electrical device. These electrical modules may electrically support the solar panels individually and collectively within an array of solar panels and, therefore, may include a number of wires extending from the electrical modules and between electrical modules of the plurality of solar panels. Using the wire management clip 100 and other wire management clips described herein, these wires may be appropriately secured and organized within the solar panel systems to avoid a potential for an electrical short or unintended wearing of the wires and/or electrical modules.

The wire management clip 100 of FIG. 1 may include a retention body 102 that may serve as a main portion of the wire management clip 100 that may retain, for example, wiring of a wire harness coupled to the electrical module or other bulk portions of wiring. The retention body 102 may have a c-shaped, circular, or semi-circular or c-shaped cross-section, and a void 104 formed to allow the bulk wiring to be seated within the retention body 102. Further, the c-shaped cross-section of the retention body 102 may include an opening 148 through which the bulk wiring may be inserted into the void 104 of the retention body 102 and seated therein. The opening 148 may have a first terminus 144 and a second terminus 146.

In one example, the c-shaped cross-section of the retention body 102 may have a spring bias that resists expansion of the c-shaped cross-section, resists an increase in the size of the opening 148, resists deflection of the first terminus 144 and the second terminus 146 from a static state or state of equilibrium as depicted in FIG. 1, and/or resists an increase in a distance between the first terminus 144 and the second terminus 146. This spring bias may be implemented in other examples of wire management clips described herein. In this manner, as weight increases with the insertion of the bulk wiring into the void 104 of the retention body 102, the spring bias of the c-shaped cross-section of the retention body 102 may ensure that the shape of the c-shaped cross-section does not expand. In order to insert the bulk wiring into the void 104 of the retention body 102, a user may use force to overcome this spring bias and expand the c-shaped cross-section, increase the size of the opening 148, and/or increase the distance between the first terminus 144 and the second terminus 146. More regarding the insertion and retention of the bulk wiring into the void 104 of the retention body 102 is described herein.

The wire management clip 100 of FIG. 1 may further include at least one friction channel to retain a wire therein. The friction channels described in connection with the embodiments presented herein may be used to not only retain a wire therein, but also to apply friction to the wire and allow the wire to be made taut over a length of the wire such that slack is taken up as the wire may extend across a length of the one or more solar panels within an array of solar panels. The reason wiring may need to be retained and slack taken up along the length of the wire is to ensure that the wire does not extend past framing of the solar panel arrays, sags below the framing, and the slack comes into contact with the mounting surface, become exposed from an underneath portion of the solar panel arrays, and/or become exposed to sunlight, precipitation, wind, and other types of environmental forces that may compromise the integrity of the wiring as a mechanical load bearing device, electric current carrier, and/or a telecommunication signals transmission device.

In the example of FIG. 1, the wire management clip 100 may include a first friction channel 106 and a second friction channel 118. The first friction channel 106 may include a base 108, a first side 112-1, and a second side 112-2 defining a generally u-shaped void 110 in which the wire may be seated. In one example, portions of the base 108 and/or the first side 112-1 form part of the retention body 102 and may be monolithically formed together as depicted in FIG. 1. The first friction channel 106 may be dimensioned to retain, for example, an oval form factor wire (e.g., a Q cable developed and distributed by Enphase Energy, Inc.) or two circular form factor wires (e.g., PV wires).

The first friction channel 106 may further include a first protrusion 116-1 and a second protrusion 116-2 (collectively referred to herein as protrusion(s) 116) located at an end of the first side 112-1 and the second side 112-2, respectively. The protrusions 116 may extend into the void 110 such that when a wire is seated within the void 110 at the base 108 and between the first side 112-1 and the second side 112-2, the protrusions 116 restrict movement of the wire away from a seated state on the base 108 and out of the void 110. The first friction channel 106 may further include a release appendage 114 extending from the second side 112-2 and the second protrusion 116-2. The release appendage 114 may further function as a lead-in feature that may be used to assist a user in engaging a wire with the first friction channel 106.

In a manner similar to the retention body, the first friction channel 106 may have a spring bias that resists expansion of the void 110, resists an increase in the size of the opening of the void 110, and/or resists an increase in a distance between the first side 112-1 and the second side 112-2. In this manner, as a wire is inserted into the void 110, the spring bias of the first friction channel 106 may ensure that the wire is friction fit into the void 110 and seated in the base 108 and between the first side 112-1 and the second side 112-2 such that the wire is secured within the void 110. In one example, the spring bias of the first friction channel 106 may create a friction fit between the first friction channel 106 and the wire to ensure that the wire may not easily move out of the first friction channel 106 or move laterally along a length of the wire as the wire is seated within the first friction channel 106. In order to insert the wire into the void 110 of the first friction channel 106, a user may use force against the release appendage 114 to overcome this spring bias and expand of the void 110, increase in the size of the opening of the void 110, and/or increase the distance between the first side 112-1 and the second side 112-2. The user may then insert the wire into the void 110 of the first friction channel 106 and remove the force applied to the release appendage 114. Once the force applied to the release appendage 114 is removed, the wire may be secured in the first friction channel 106 via the spring bias. In one example, the spring bias of the first friction channel 106 may create a friction fit between the wire and the base 108, the first side 112-1, and/or the second side 112-2 such that the wire is unable to move in any direction including out of the first friction channel 106 or laterally along a length of the wire as the wire is seated within the first friction channel 106 as described above. In order to remove the wire from the first friction channel 106, the user may again apply force to the release appendage 114 to overcome the spring bias of the first friction channel 106 and remove the wire from inside the first friction channel 106. The spring bias of the first friction channel 106 may ensure that slack of the wire may be taken up and the wire may be secured at a desire point along the length of the wire within the first friction channel 106.

In a manner similar to the first friction channel 106, the second friction channel 118 may include a base 120, a first side 124-1, and a second side 124-2 defining a generally u-shaped void 122 in which the wire may be seated. In one example, portions of the base 120 and/or the first side 124-1 form part of the retention body 102 and may be monolithically formed together as depicted in FIG. 1. It is noted that the second terminus 146 of the retention body 102 is formed by an opposite side of the base 120. The second friction channel 118 may be dimensioned to retain, for example, an oval form factor wire (e.g., a Q cable developed and distributed by Enphase Energy, Inc.) or two circular form factor wires (e.g., PV wires).

The second friction channel 118 may further include a first protrusion 126-1 and a second protrusion 126-2 (collectively referred to herein as protrusion(s) 126) located at an end of the first side 124-1 and the second side 124-2, respectively. The protrusions 126 may extend into the void 122 such that when a wire is seated within the void 122 at the base 120 and between the first side 124-1 and the second side 124-2, the protrusions 126 restrict movement of the wire away from a seated state on the base 120 and out of the void 122 The second friction channel 118 may further include a release appendage 128 extending from the second side 124-2 and the second protrusion 126-2. Further, as similarly described above in connection with the release appendage 114 of the first friction channel 106, the release appendage 128 may further function as a lead-in feature that may be used to assist a user in engaging a wire with the second friction channel 118.

In a manner similar to the retention body, the second friction channel 118 may have a spring bias that resists expansion of the void 122, resists an increase in the size of the opening of the void 122, and/or resists an increase in a distance between the first side 124-1 and the second side 124-2. In this manner, as a wire is inserted into the void 122, the spring bias of the second friction channel 118 may ensure that the wire is friction fit into the void 122 and seated in the base 120 and between the first side 124-1 and the second side 124-2 such that the wire is secured within the void 122. In one example, the spring bias of the second friction channel 118 may create a friction fit between the second friction channel 118 and the wire to ensure that the wire may not easily move out of the second friction channel 118 or move laterally along a length of the wire as the wire is seated within the second friction channel 118. In order to insert the wire into the void 122 of the second friction channel 118, a user may use force against the release appendage 128 to overcome this spring bias and expand the void 122, increase in the size of the opening of the void 122, and/or increase the distance between the first side 124-1 and the second side 124-2. The user may then insert the wire into the void 122 of the second friction channel 118 and remove the force applied to the release appendage 128. Once the force applied to the release appendage 128 is removed, the wire may be secured in the second friction channel 118 via the spring bias. In one example, the spring bias of the second friction channel 118 may create a friction fit between the wire and the base 120, the first side 124-1, and/or the second side 124-2 such that the wire is unable to move in any direction including out of the second friction channel 118 or laterally along a length of the wire as the wire is seated within the second friction channel 118 as described above. In order to remove the wire from the second friction channel 118, the user may again apply force to the release appendage 128 to overcome the spring bias of the second friction channel 118 and remove the wire from inside the second friction channel 118. The spring bias of the second friction channel 118 may ensure that slack of the wire may be taken up and the wire may be secured at a desire point along the length of the wire within the second friction channel 118. Further, the release appendage 128 may be utilized by a user to apply force to overcome spring bias of the retention body 102 and expand the c-shaped cross-section, increase the size of the opening 148, and/or increase the distance between the first terminus 144 and the second terminus 146.

In one example, the first friction channel 106 and the second friction channel 118 may be dimensioned and/or configured to fit types of wires where the wires have different characteristics, features, or purposes. For example, the first friction channel 106 and the second friction channel 118 may be dimensioned and/or configured to fit different gauges of wires. Further, in one example, the first friction channel 106 and the second friction channel 118 may be dimensioned and/or configured to fit wires that are to be run along a length of the solar panel arrays in different directions and/or to devices within the solar panel array that serve different purposes or functions. In one example, the first friction channel 106 and the second friction channel 118 may be located on opposite sides of the retention body 102 as depicted in FIG. 1, or closer to one another depending on a desired or intended function of the wire management clip 100. Further, as mentioned herein, the first friction channel 106 and the second friction channel 118 may be monolithically formed with the retention body 102. However, the first friction channel 106 and the second friction channel 118 may be coupled to the retention body 102 in any manner.

In the example depicted in FIG. 1, a longitudinal axis of the first friction channel 106 and the second friction channel 118 may lie along the x-axis of the wire management clip 100. However, in other examples, the first friction channel 106 and the second friction channel 118 may be formed or mounted on the retention body 102 at any angle to allow for the wire(s) to be coupled to the first friction channel 106 and the second friction channel 118 at different orientations or angles with respect to the frame 206 and/or the retention body 102. Indeed, the longitudinal axis of the first friction channel 106 and the second friction channel 118 may lie along any angle from that presented in FIG. 1. This may allow the retention body 102, the first friction channel 106, and/or the second friction channel 118 to be oriented with respect to the frame 206 and the mounting channel 130 differently as that depicted in FIGS. 1 through 4. For example, the first friction channel 106 and/or the second friction channel 118 may be oriented so that the opening is facing in a direction opposite than that depicted in FIG. 1 (e.g., down versus up or up versus down). Further, in one example, the opening of the first friction channel 106 and/or the second friction channel 118 may both be oriented up or both be oriented down. However, the opening or the longitudinal axis of the first friction channel 106 and/or the second friction channel 118 may be oriented in any direction.

The wire management clip 100 may further include a mounting channel 130 via which the wire management clip 100 may be coupled and secured to, for example, a return flange of the solar panel arrays or other portions of the solar panel arrays. In one example, the solar panel arrays may include solar panels supported by a frame made of, for example, a metal that includes a return flange to which the wire management clip 100 may be coupled. The mounting channel 130 may engage with the return flange of the frame of the solar panel and withstand removal from the return flange. As depicted in FIG. 1, for example, the mounting channel 130 may include a base 132, a first side 134-1, and a second side 134-2 defining a generally u-shaped void 136 in which the return flange may be seated. In one example, portions of the base 132 and/or the first side 134-1 may form part of the retention body 102 and may be monolithically formed together as depicted in FIG. 1. Further, in one example, portions of the base 132 and/or the first side 134-1 may form part of the base 108 and/or first side 112-1 of the first friction channel 106 and may be monolithically formed together as depicted in FIG. 1.

The void 136 of the mounting channel 130 may be dimensioned and/or configured to couple with the return flange such that insertion of the return flange into the void 136 may secure the wire management clip 100 to the return flange via a friction fit or other type of interference fit. In one example, the base 132 may include a shape that may match an end of the return flange. For example, the base 132 may include a semicircular shape that may match a blunted end of the return flange to allow of the return flange to more tightly engage with the base 132. Further, in one example, the base 132 may include a semi-circular or oval shape that serves as a strain relief within the mounting channel 130 to accommodate for a relatively larger thickness of a return flange to which the mounting channel 130 is to interface.

Further, in order to retain the coupling of the wire management clip 100 to the return flange, at least one tooth may be included within the void 136. The at least one tooth 138 may be angled into the void 136 and toward an interior of the void 136 such as toward the base 132 in order to provide for an easy push-connection that allows for the wire management clip 100 to be relatively easier to engage with the return flange but that is relatively harder to disengage from the return flange. The at least one tooth 138 may be couped to the first side 134-1 and/or the second side 134-2 and to an interior portion of the void 136. At least one socket aperture 140 may be defined in the first side 134-1 and/or the second side 134-2 to provide a portion of the at least one tooth 138 to be coupled to the mounting channel 130. In one example, the at least one tooth 138 may be glued or press fitted into the at least one socket aperture 140 in order to securely couple the at least one tooth 138 to the interior of the mounting channel 130.

In one example, the wire management clip 100 may be formed through an extrusion process wherein the at least one tooth 138 may be co-extruded with at least a portion of the wire management clip 100 and may be achieved in examples where the materials from which the wire management clip 100 are different from the material from which the at least one tooth 138 is made. In other words, the at least one tooth 138 may be made of a material that is different from the material from which the wire management clip 100 and/or the surrounding portions of the mounting channel 130 are made. In one example, the at least one tooth 138 may be made of a material that has a relatively higher coefficient of friction than the return flange and/or the surrounding portions of the mounting channel 130. In other words, the at least one tooth 138 may be made of a material that has a relatively higher coefficient of friction when interfacing with the material of the return flange than a coefficient of friction that may otherwise exist between the surrounding portions of the mounting channel 130 without the tooth 138 when in combination with the return flange. When describing comparative coefficient of frictions throughout this description, the above comparison is what is meant in such a description. For example, the at least one tooth 138 may be made of a rubber, the return flange of the solar panel arrays may be made of a metal that has a relatively lower coefficient of friction relative to the rubber of the at least one tooth 138, and the surrounding portions of the mounting channel 130 may be made of a plastic, a metal or other material that has a relatively lower coefficient of friction relative to the rubber of the at least one tooth 138. In this example, the rubber of the at least one tooth 138 may be co-extruded with the plastic of the wire management clip 100 and/or the surrounding portions of the mounting channel 130.

Although one tooth 138 in FIG. 1, a plurality of teeth 138 may be included within the interior of the mounting channel 130. The plurality of teeth 138 may be located within the mounting channel 130 on both the first side 134-1 and the second side 134-2 such that the plurality of teeth 138 oppose one another as describe herein in connection with other embodiments of the wire management clip.

The second side 134-2 of the mounting channel 130 may include a sloped face 142 that may be used to assist a user in engaging the wire management clip 100 with the return flange via the mounting channel 130. As a user seeks to couple the wire management clip 100 to the return flange, the user may utilize the sloped face 142 to locate the opening of the mounting channel 130 and guide the return flange into the mounting channel 130. Further, the first side 134-1 may include the first terminus 144 formed thereon, and the first terminus 144 may provide a position into which the socket aperture 140 may be defined and the at least one tooth 138 may be coupled.

The wire management clip 100 and other examples of wire management clips described herein may have a width that runs along the x-axis and parallel to a center of the void 104 of the retention body 102. Based on this understanding of the width of the wire management clip 100, the wire management clip 100 may have any width that allows the wire management clip 100 to not rotate about the z-axis when coupled to the return flange of the solar panel arrays or other portions of the solar panel arrays. This ensures that the tension placed on the wire management clip 100 by engaging the wires in the first friction channel 106 and a second friction channel 118 and taking up slack of the wires.

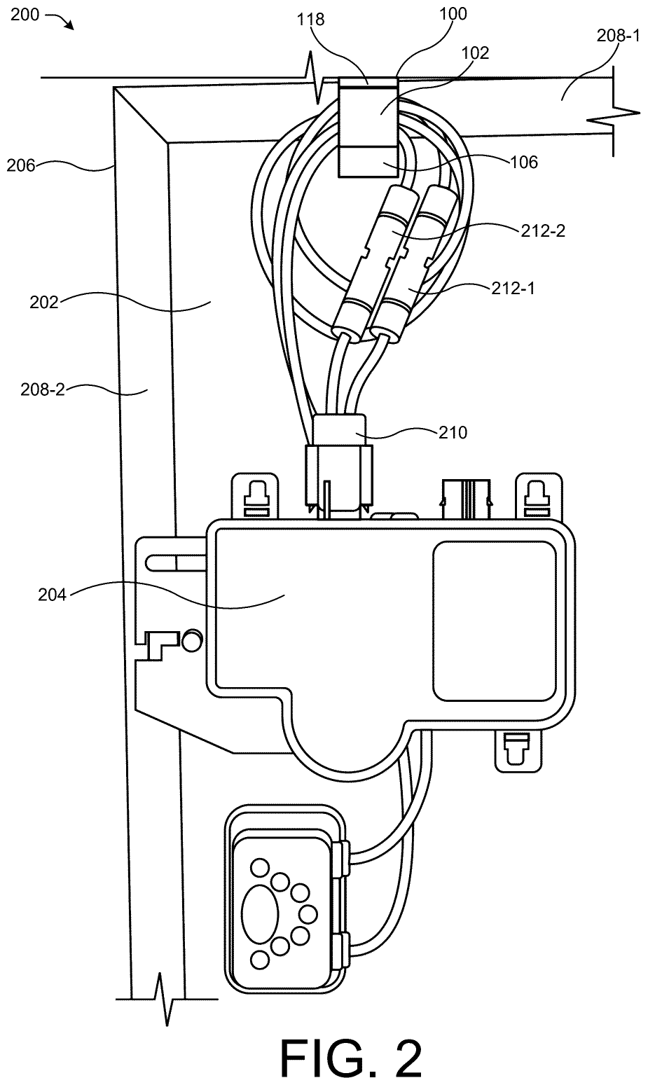

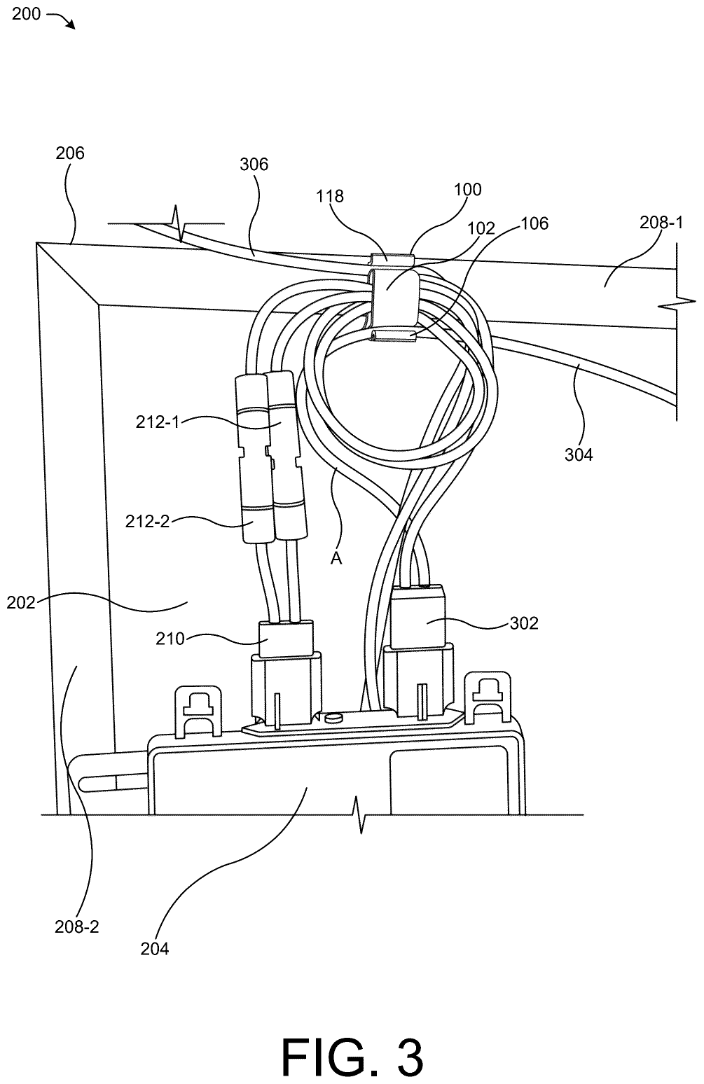

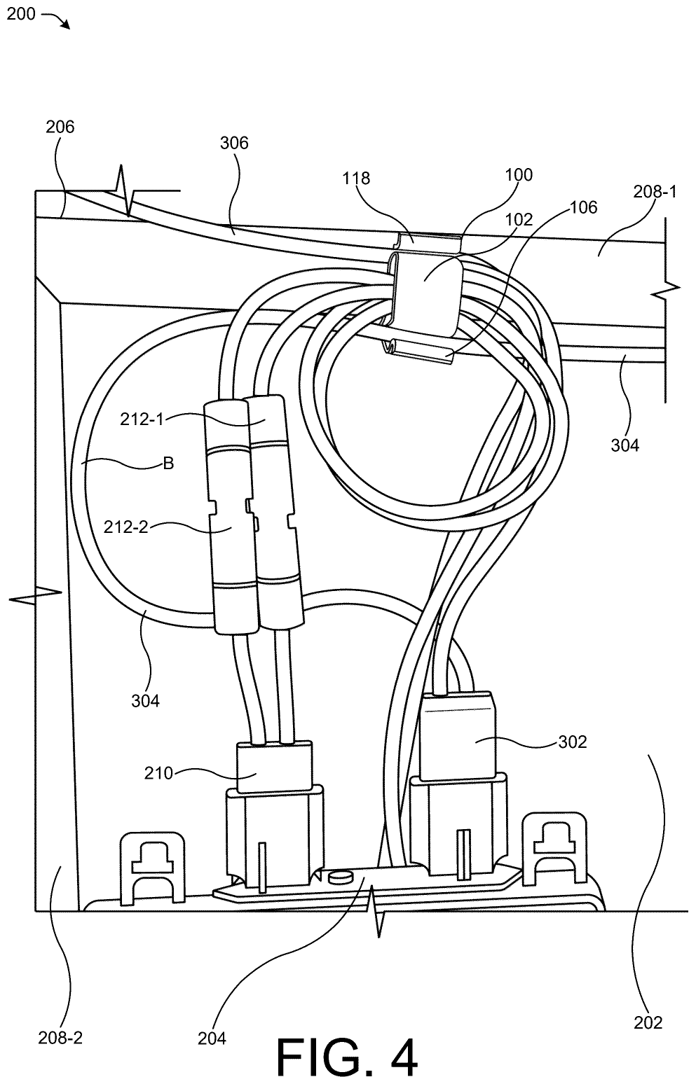

FIGS. 2 through 4 depict a method of utilizing the wire management clip 100 of FIG. 1. Specifically, FIG. 2 illustrates the wire management clip 100 of FIG. 1 in use in connection with an electrical module 204 and a frame 206 with first wiring of the electrical module 204 being retained in a retention body 102 of the wire management clip 100, according to an example of the principles described herein. FIG. 3 illustrates the wire management clip 100 of FIG. 1 in use in connection with the electrical module 204 and the frame 206 with second wiring of the electrical module 204 being retained in the first friction channel 106 and the second friction channel 118 of the wire management clip 100, according to an example of the principles described herein. FIG. 4 illustrates the wire management clip 100 of FIG. 1 in use in connection with the electrical module 204 and the frame 206 with slack of the second wiring being taken up in the second friction channel 118 of the wire management clip 100, according to an example of the principles described herein. It is noted here that the views presented in FIG. 2 through 4 depict a back or underside of a solar panel system 200 and the reverse side may include photovoltaic cells used in converting sunlight into electricity. The wire management clip 100 may be coupled to the frame 206 at a first portion 208-1 or a second portion 208-2 of the frame 206 via the mounting channel 130. Thus, in FIGS. 2 through 4, the mounting channel 130 is not shown, but the retention body 102, the first friction channel 106, and the second friction channel 118 are depicted.

The electrical module 204 physically and electrically coupled to individual solar panels may include any module-level-power or electronic device such as a microinverter, an electrical junction box, a power optimizer, or similar electrical device. In one example, the electrical module 204 may assist the solar panel 202 in the generation of electrical power from sunlight. Further, in one example, the electrical module 204 may assist in controlling the solar panel 202. In one example, individual solar panels 202 may or may not include an electrical module 204 coupled to the solar module frame, and the wiring may only include wires from the solar panel 202 or neighboring solar panels 202 in an array of solar panels and not from the electrical module 204. Further, in one example,

Starting with FIG. 2, the wire management clip 100 may be coupled to a first portion 208-1 of the frame 206. Further, the electrical module 204 may be coupled to a second portion 208-2 of the frame 206. The electrical module 204 may include any electrical module electrically coupled to the solar panel 202 such as an electrical junction box, a power optimizer, or similar electrical device as mentioned above. The electrical module 204 may be electrically coupled to the solar panel 202 and other solar panels 202 of other solar panels an overall solar panel array via a first wire harness 210. The first wire harness 210 may be coupled to the electrical module 204 and may include a first wire 212-1 and a second wire 212-2 extending therefrom. In one example, the first wire 212-1 and the second wire 212-2 may be directly coupled between the electrical module 204 and the solar panel 202.

The first wire 212-1 and the second wire 212-2 may be coupled to the electrical module 204 and may include more length of wire than may be required. As depicted in FIGS. 2 through 4, the first wire 212-1 and the second wire 212-2 may be coiled up and secured in the retention body 102 of the wire management clip 100. This ensures that the first wire 212-1 and the second wire 212-2 are secured to, for example, the first portion 208-1 (or second portion 208-2) of the frame 206 and keeps the first wire 212-1 and the second wire 212-2 organized underneath the solar panel system 200. Further, coupling the first wire 212-1 and the second wire 212-2 to the solar panel system 200 in this manner keeps the first wire 212-1 and the second wire 212-2 out of contact with a mounting surface on which the solar panel system 200 is mounted and ensures that environmental forces do not negatively affect the function and integrity of the first wire 212-1 and the second wire 212-2.

Further, as depicted in FIGS. 3 and 4, the electrical module 204 may further include a second wire harness 302 coupled to the electrical module 204. The second wire harness 302 may, in turn, be coupled to an input wire 304 and an output wire 306. The input wire 304 may include a wire coupled to the electrical module 204 from a second solar panel system 200 that is electrically upstream from the solar panel system 200 depicted in FIGS. 2 through 4. Further, the output wire 306 may include a wire coupled to a solar panel system 200 that is electrically downstream from the electrical module 204 of the solar panel system 200 depicted in FIGS. 2 through 4. Since the input wire 304 and the output wire 306 extend to additional solar panel systems, the length of the input wire 304 and/or the output wire 306 needed for connection may vary, and during installation the wires may be at a length that is longer than required for the installation of a series of solar panels within an array of solar panels. Because the length of the input wire 304 and/or the output wire 306 may be longer, the input wire 304 and the output wire 306 may be coupled to the first friction channel 106 and the second friction channel 118, respectively. Further, in one example, excess length of the input wire 304 and/or the output wire 306 may be secured within the retention body 102.

As to the output wire 306, coupling the output wire 306 to the second friction channel 118 may include initially coupling the output wire 306 to the second friction channel 118 as depicted in FIGS. 3 and 4 which depicts any slack in the output wire 306 being taken up and pulled through the second friction channel 118 such that no slack is present between the second wire harness 302 and the wire management clip 100. Since the output wire 306 serves as an input wire 304 for a solar panel system 200 electrically downstream from the solar panel system 200 depicted in FIGS. 2 through 4, any additional length or slack that may exist in the output wire 306 may be addressed at that electrically downstream solar panel system 200 as described above in connection with the input wire 304. The second friction channel 118 thus serves as an anchor that may allow for the slack of the output wire 306 to be taken up at the subsequent solar panel system 200 were a second wire management clip 100 may similarly be installed and provide the functionality as described above. In this manner, the output wire 306 may be kept out of contact with a mounting surface on which the solar panel system 200 is mounted and ensures that environmental forces do not negatively affect the function and integrity of the output wire 306.

Any number of wire management clips 100 may be attached at any position along the length of the first portion 208-1 and/or the second portion 208-2 of the frame 206 to provide additional support for the first wire 212-1, the second wire 212-2, the input wire 304, and/or the output wire 306 as described above. In describing the various embodiments of wire management clips presented herein, aspects or elements of the wire management clip 100 of FIGS. 1 through 4 may be included or not included in those embodiments. Further, the various embodiments of wire management clips presented herein may include additional aspects or elements that may similarly be applied to other embodiments presented herein.

In the example depicted in FIG. 1, a longitudinal axis of the mounting channel 130 may lie along the y-axis of the wire management clip 100. However, in other examples, the mounting channel 130 may be formed or mounted on the retention body 102 at any angle to allow for the wire management clip 100 to be coupled to the frame 206 at different orientations or angles with respect to the frame 206. This may allow the retention body 102, the first friction channel 106, and/or the second friction channel 118 to be oriented with respect to the frame 206 and the mounting channel 130 differently as that depicted in FIGS. 1 through 4.

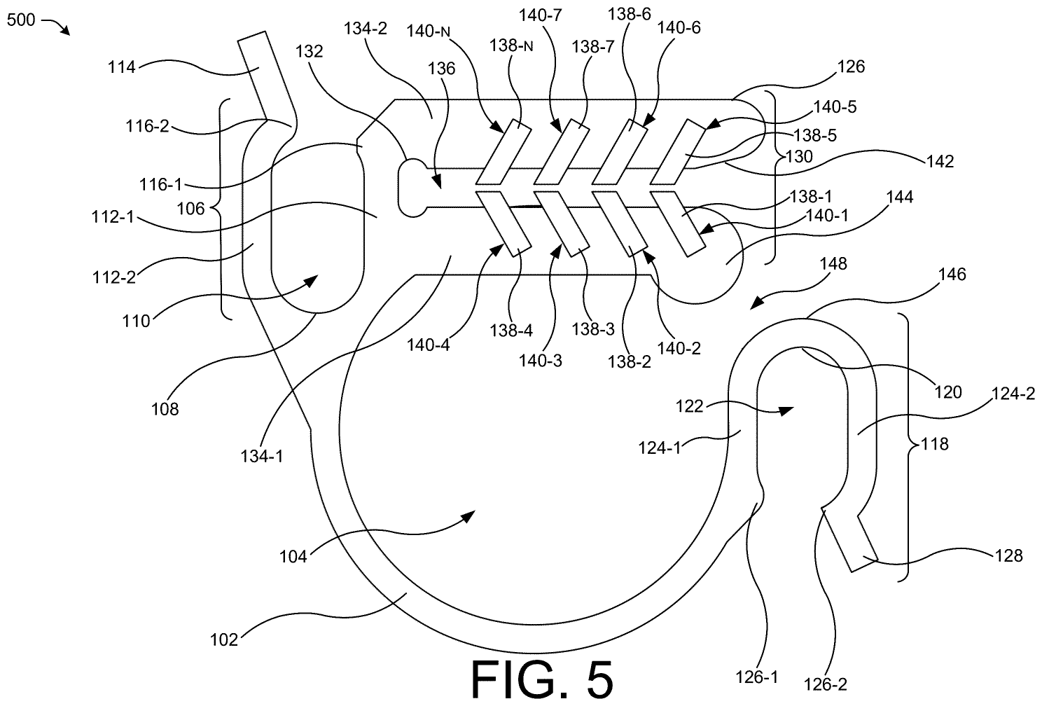

FIG. 5 illustrates a wire management clip 500, according to an example of the principles described herein. The wire management clip 500 of FIG. 5 may include similar elements described above in connection with the wire management clip 100 of FIG. 1. The wire management clip 500 of FIG. 5 may include the retention body 102, the void 104 defined therein, the opening 148 defined by the first terminus 144 and the second terminus 146, the first friction channel 106, and the second friction channel 118. The first friction channel 106 may include the base 108, the first side 112-1, and the second side 112-2 defining the u-shaped void 110.

The first friction channel 106 may further include the first protrusion 116-1 and the second protrusion 116-2 (collectively referred to herein as protrusion(s) 116). Similarly, the second friction channel 118 may include the base 120, the first side 124-1, and the second side 124-2 defining the u-shaped void 122 in which the wire may be seated. The second friction channel 118 may further include the first protrusion 126-1 and the second protrusion 126-2 (collectively referred to herein as protrusion(s) 126).

The wire management clip 500 may further include the mounting channel 130 via which the wire management clip 500 may be coupled and secured to, for example, the return flange of the frame 206 of the solar panel system 200 or other portions of the solar panel system 200. The mounting channel 130 may include the base 132, the first side 134-1, and the second side 134-2 defining the u-shaped void 136 in which the return flange may be seated. The above-described elements of the wire management clip 500 may have identical or similar features and functions of those similar elements described above in connection with the wire management clip 100 of FIG. 1.

The second side 134-2 of the mounting channel 130 may include a sloped face 142 that may be used to assist a user in engaging the wire management clip 500 with the return flange via the mounting channel 130. Further, the first side 134-1 may include the first terminus 144 formed thereon, and the first terminus 144 may provide a position into which the socket aperture 140 may be defined and the at least one tooth 138 may be coupled.

Further, in order to retain the coupling of the wire management clip 500 to the return flange, the void 136 may include at least one tooth as described above, and, in the example of FIG. 5, may include a plurality of teeth 138-1, 138-2, 138-3, 138-4, 138-5, 138-6, 138-7, . . . 138-N (where N is any integer greater than or equal to 1 (collectively referred to herein as tooth or teeth 138 unless specifically addressed otherwise)) within the void 136. The teeth 138 may be angled into the void 136 and toward an interior of the void 136 such as toward the base 132 in order to provide for an easy push-connection that allows for the wire management clip 500 to be relatively easier to engage with the return flange and that is relatively harder to disengage from the return flange. The teeth 138 of the example of FIG. 5 may be couped to the first side 134-1 and the second side 134-2 and may extend into an interior portion of the void 136. The teeth 138 may be coupled to the mounting channel 130 via a plurality of socket apertures 140-1, 140-2, 140-3, 140-4, 140-5, 140-6, 140-7, 140-N (where N is any integer greater than or equal to 1 (collectively referred to herein as socket aperture(s) 140 unless specifically addressed otherwise)) defined in the first side 134-1 and/or the second side 134-2 to provide a portion of the teeth 138 to be coupled to the mounting channel 130, respectively. In one example, the teeth 138 may be glued or press fitted into the at least one socket aperture 140 in order to securely couple the teeth 138 to the interior of the mounting channel 130. Further, in one example, the wire management clip 100 may be formed through an extrusion process wherein the at least one tooth 138 may be co-extruded with at least a portion of the wire management clip 500 and may be achieved in examples where the materials from which the wire management clip 500 are different from the material from which the at least one tooth 138 is made. Thus, the wire management clip 500 of FIG. 5 may include a plurality of teeth 138 to further secure the wire management clip 500 to the return flange of the frame 206 through additional or increased friction created between the teeth 138 and the return flange. Further, as mentioned above, the plurality of teeth 138 may be located within the mounting channel 130 on both the first side 134-1 and the second side 134-2 such that the plurality of teeth 138 oppose one another to even further increase the coefficient of friction through the application of additional force against the return flange.

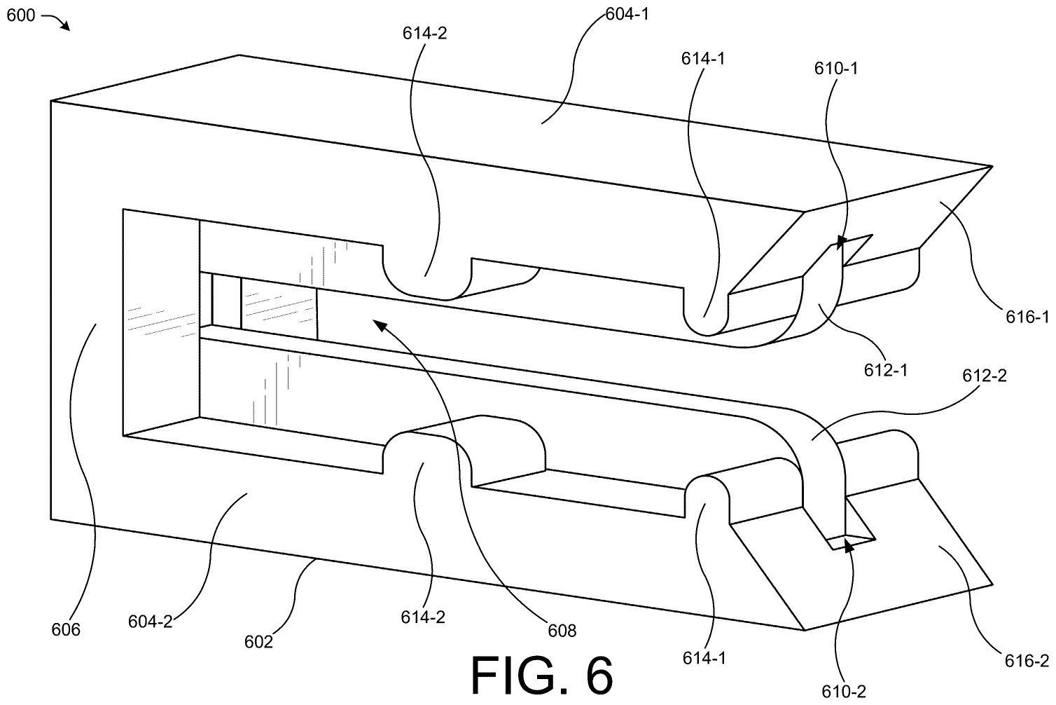

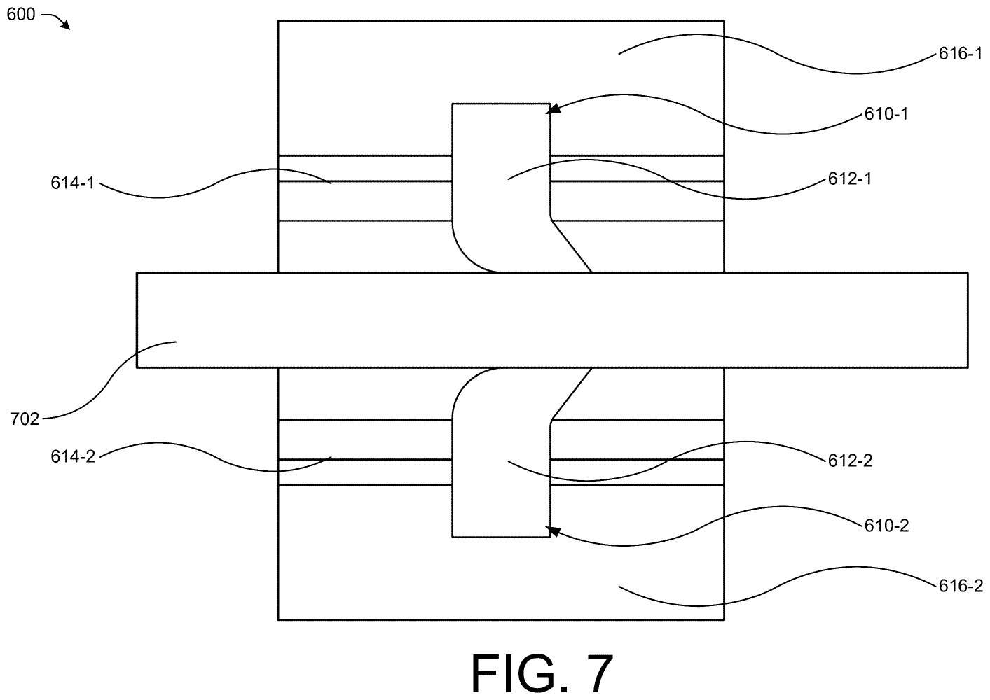

FIG. 6 illustrates a wire management clip 600, according to an example of the principles described herein. FIG. 7 illustrates the wire management clip 600 of FIG. 6 including a wire 702 engaged therewith, according to an example of the principles described herein. The wire management clip 600 of FIGS. 6 and 7 may include elements similar to or different from other examples described herein. The wire management clip 600 may include a retention body 602 with a c-shaped cross-section. The retention body 602 may include a first side 604-1 and a second side 604-2 coupled via a base 606 that together form the c-shaped cross-section. The first side 604-1, the second side 604-2, and the base 606 form a void 608 into which a return flange and/or a number of wires 702 may be seated.

The first side 604-1 may include a first channel 610-1 defined in the first side 604-1, and the second side 604-2 may include a second channel 610-2 defined in the second side 604-2. In one example, the first channel 610-1 and the second channel 610-2 may also be defined in at least a portion of the base 606. The first channel 610-1 and the second channel 610-2 may allow for a first tooth 612-1 and a second tooth 612-2 to be inserted therein. The first tooth 612-1 and the second tooth 612-2 may function in a similar manner as other teeth described herein by increasing a force against a wire and/or the return flange and increasing the coefficient of friction relative to the wire and/or the return flange and retain the wire and/or the return flange in the void 608. In one example, the first tooth 612-1 and the second tooth 612-2 may be made of a rubber material that has a relatively higher coefficient of friction than other materials to allow for the first tooth 612-1 and the second tooth 612-2 to secure the wire and/or the return flange as described herein.

The wire management clip 600 of FIGS. 6 and 7 may further include a first set of protrusions 614-1 and a second set of protrusions 614-2. The first set of protrusions 614-1 and the second set of protrusions 614-2 may allow for any wires 702 inserted into the void 608 to be located at a back of the void 608 when placed past the second set of protrusions 614-2 towards the base 606 or located towards the front of the void 608 when placed between the first set of protrusions 614-1 and the second set of protrusions 614-2. This allows for the wires that are inserted into to the void 608 to be compartmentalized or located at discrete portions within the void 608.

Further, the wire management clip 600 of FIGS. 6 and 7 may include a first sloped face 616-1 and a second sloped face 616-2. The first sloped face 616-1 and the second sloped face 616-2 may be used to assist a user in engaging the wire management clip 600 with the return flange via the void 608 and/or assist the user in engaging the wire 702 within the void 608. In one example, the wire management clip 600 of FIGS. 6 and 7 may be engaged with the return flange of the frame 206 via the void 608. In other words, the void 608 may be large enough to accommodate both the return flange of the frame 206 and at least one wire 702.

However, in one example, the void 608 may be dimensioned to accommodate at least one wire 702. In this example, the wire management clip 600 may be coupled to the return flange of the frame 206 or other parts of the frame 206 via affixing the wire management clip 600 to the frame 206 via another means other than inserting the return flange of the frame 206 into the void 608. In this example, the wire management clip 600 may be glued to the frame 206 via the use of an adhesive, affixed to the frame 206 via a fastener or fastening device, or through other affixing means.

As depicted in FIG. 7, a wire 702 is depicted as being engaged in the wire management clip 600. The slack or extra length of the wire 702 may be pulled from the left or right as depicted in FIG. 7 to ensure that the wire 702 remains taut over a length of the wire 702 such that slack is taken up as the wire 702 may extend across a length of the one or more solar panel systems 200. When the slack in the wire 702 is taken up, the first tooth 612-1 and/or the second tooth 612-2 may become deformed. For example, the first tooth 612-1 and the second tooth 612-2 may be made of a rubber that allows for such deformation to take place. The deformation of the first tooth 612-1 and/or the second tooth 612-2 prevents the wire 702 to be moved laterally through the wire management clip 600, and may be specifically effective in restricting movement of the wire 702 through the wire management clip 600 in a direction opposite the direction the slack of the wire 702 was pulled through the wire management clip 600.

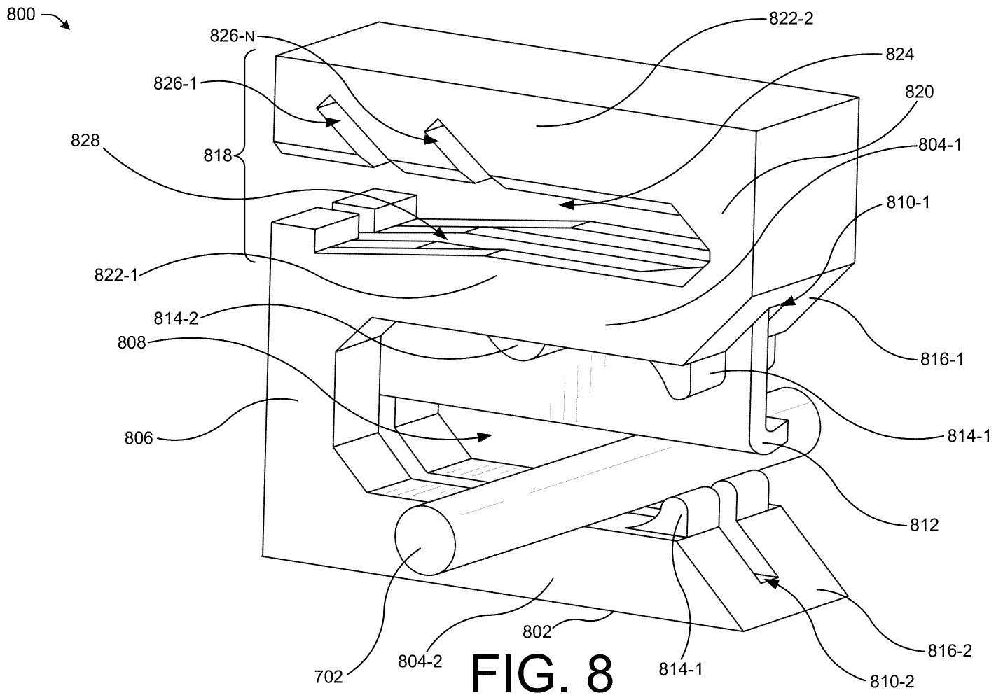

FIG. 8 illustrates a wire management clip 800 including a wire 702 engaged therewith, according to an example of the principles described herein. The wire management clip 800 of FIG. 8 may include elements similar to or different from other examples described herein. The wire management clip 800 may include a retention body 802 with a c-shaped cross-section. The retention body 802 may include a first side 804-1 and a second side 804-2 coupled via a base 806 that together form the c-shaped cross-section. The first side 804-1, the second side 804-2, and the base 806 form a void 808 into which a return flange and/or a number of wires 702 may be seated.

The first side 804-1 may include a first channel 810-1 defined in the first side 804-1, and the second side 804-2 may include a second channel 810-2 defined in the second side 804-2. In one example, the first channel 810-1 and the second channel 810-2 may also be defined in at least a portion of the base 806. The first channel 810-1 and the second channel 810-2 may allow for at least a tooth 812 to be inserted therein. Although not shown, a second tooth may be inserted into the second channel 810-2 in a manner similar to other examples described herein. The tooth 812 may function in a similar manner as other teeth described herein by increasing a force against a wire 702 and/or the return flange and increasing the coefficient of friction relative to the wire 702 and/or the return flange and retain the wire 702 and/or the return flange in the void 808. In one example, the tooth 812 may be made of a rubber material that has a relatively higher coefficient of friction than other materials to allow for the tooth 812 to secure the wire 702 and/or the return flange as described herein.

The wire management clip 800 of FIG. 8 may further include a first set of protrusions 814-1 and a second set of protrusions 814-2. The first set of protrusions 814-1 and the second set of protrusions 814-2 may allow for any wires 702 inserted into the void 808 to be located at a back of the void 808 when placed past the second set of protrusions 814-2 towards the base 806 or located towards the front of the void 808 when placed between the first set of protrusions 814-1 and the second set of protrusions 814-2. This allows for the wires 702 that are inserted into to the void 808 to be compartmentalized or located at discrete portions within the void 808.

Further, the wire management clip 800 of FIG. 8 may include a first sloped face 816-1 and a second sloped face 816-2. The first sloped face 816-1 and the second sloped face 816-2 may be used to assist a user in engaging the wire 702 within the void 808. Like the example of FIGS. 6 and 7, in one example, the void 808 may be dimensioned to accommodate at least one wire 702. In this example, the wire management clip 800 may be coupled to the return flange of the frame 206 or other parts of the frame 206 via affixing the wire management clip 800 to the frame 206 via another means. In this example, the wire management clip 800 may be glued to the frame 206 or the back sheet of the solar panel 202 via the use of an adhesive, affixed to the frame 206 via a fastener or fastening device, or through other affixing means.

As depicted in FIG. 8, a wire 702 is depicted as being engaged in the wire management clip 800. The slack or extra length of the wire 702 may be pulled from the left or right as depicted in FIG. 8 to ensure that the wire 702 remains taut over a length of the wire 702 such that slack is taken up as the wire 702 may extend across a length of the one or more solar panel systems 200. When the slack in the wire 702 is taken up, the tooth may become deformed. For example, the tooth 812 may be made of a rubber that allows for such deformation to take place. The deformation of the tooth prevents the wire 702 to be moved laterally through the wire management clip 800 in a direction opposite the direction the slack of the wire 702 was pulled through the wire management clip 800.

In one example, the wire management clip 800 of FIG. 8 may be engaged with the return flange of the frame 206 via the void 808. In other words, the void 808 may be large enough to accommodate both the return flange of the frame 206 and at least one wire 702. In one example, the wire management clip 800 may be engaged with the return flange via the void 808 and the first sloped face 816-1 and the second sloped face 816-2 may be used to assist a user in engaging the wire management clip 800 with the return flange. Despite the potential to insert the return flange into the void 808 along with the wire 702, in one example, the wire management clip 800 may further include a mounting channel 818 via which the wire management clip 800 may be coupled and secured to, for example, the return flange of the solar panel system 200 or other portions of the solar panel system 200. The mounting channel 818 may include the base 820, a first side 822-1, and a second side 822-2 defining the u-shaped void 824 in which the return flange may be seated. The above-described elements of the wire management clip 800 may have identical or similar features and functions of those similar elements described above in connection with the wire management clips of FIGS. 1 through 8.

Further, in order to retain the coupling of the wire management clip 800 to the return flange, at least one tooth as described above, and, in the example of FIG. 8, may include a plurality of teeth 138 within the void 824 as depicted in, for example, FIG. 5. The teeth 138 may be angled into the void 824 and toward an interior of the void 824 such as toward the base 820 in order to provide for an easy push-connection that allows for the wire management clip 800 to be relatively easier to engage with the return flange and that is relatively harder to disengage from the return flange. The teeth 138 of the example of FIG. 8 may be couped to the first side 822-1 and/or the second side 822-2 and to an interior portion of the void 824. The teeth 138 may be coupled to the mounting channel 818 via a plurality of socket apertures 826-1, . . . 826-N (where N is any integer greater than or equal to 1 (collectively referred to herein as socket aperture(s) 826 unless specifically addressed otherwise)) defined in the first side 822-1 and/or the second side 822-2 to provide a portion of the teeth 138 to be coupled to the mounting channel 818, respectively. The teeth 138 are not depicted in the example of FIG. 8 in order to depict the features of the socket apertures 826, but the teeth 138 may be coupled to the socket apertures 826 of the mounting channel 818 as described herein. In one example, the teeth 138 may be glued or press fitted into the socket apertures 826 in order to securely couple the teeth 138 to the interior of the mounting channel 818. Thus, the wire management clip 800 of FIG. 8 may include a plurality of teeth 138 to further secure the wire management clip 800 to the return flange of the frame 206 through additional or increased friction created between the teeth 138 and the return flange. Further, as mentioned above, the plurality of teeth 138 may be located within the mounting channel 818 on both the first side 822-1 and the second side 822-2 such that the plurality of teeth 138 oppose one another to even further increase the coefficient of friction through the application of additional force against the return flange.

The wire management clip 800 may include a through channel 828. The through channel 828 may be formed between the mounting channel 818 and into the retention body 802. The through channel 828 may also be formed in at least a portion of the base 806, the first side 804-1 and/or the first side 822-1 such that the tooth 812 may be inserted into the through channel 828 during manufacture or as the tooth 812 may wear or be replaced with a tooth 812 made of a different material such as rubber material with a different elasticity.

In one example, the tooth 812 may include a t-shaped profile where the t-portion of the tooth 812 mounts within or seats on the through channel 828. Further, in this example, the t-portion of the tooth 812 may also serve to create a relatively higher coefficient of friction for instances when the mounting channel 818 is utilized to mount the wire management clip 800 onto a return flange of the frame 206.

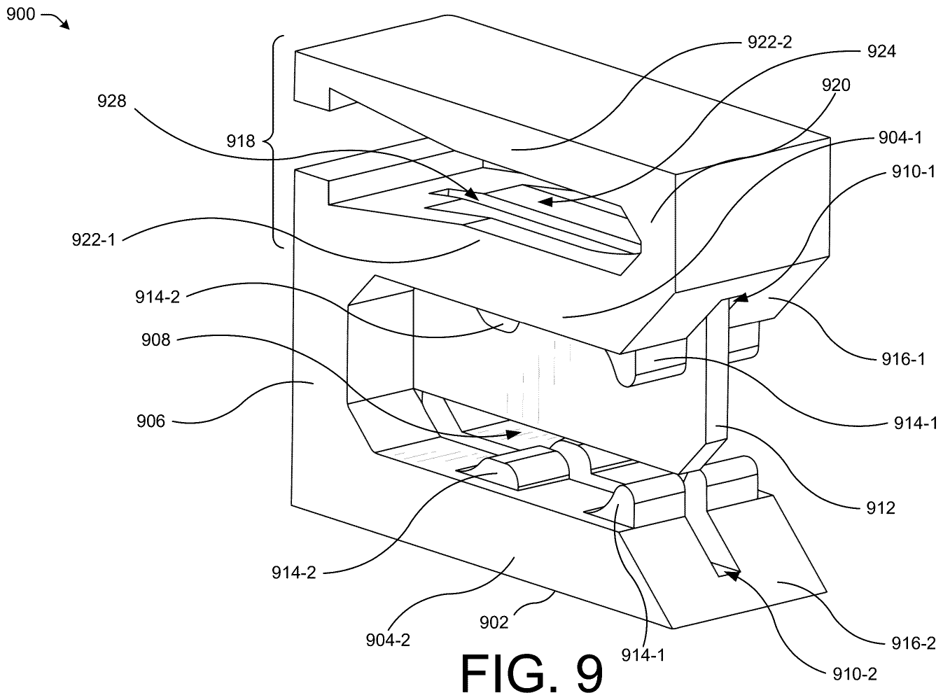

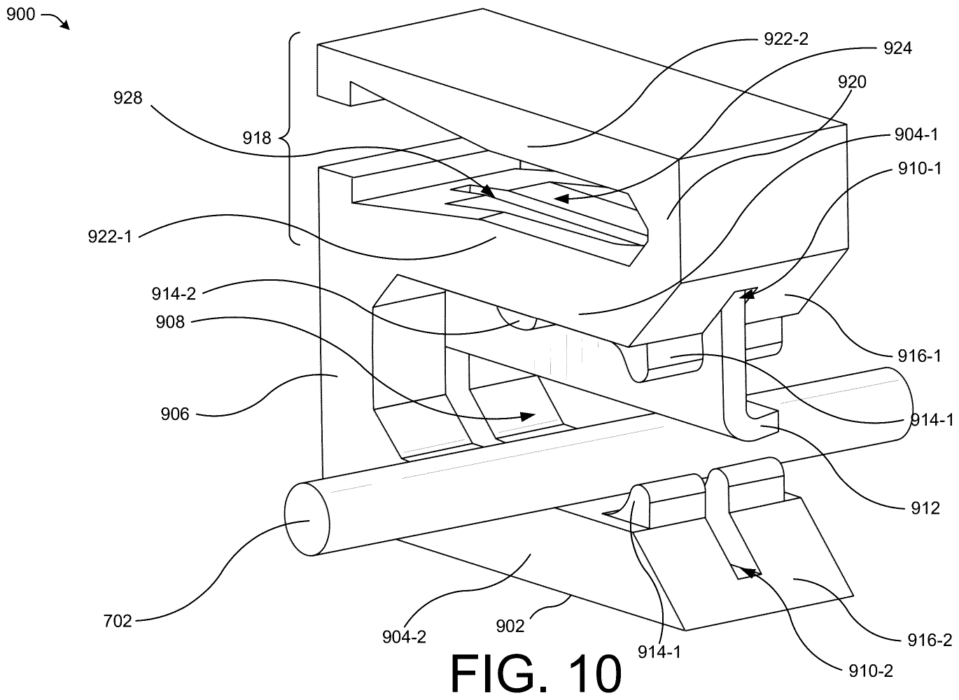

FIG. 9 illustrates a wire management clip 900, according to an example of the principles described herein. FIG. 10 illustrates the wire management clip of FIG. 9 including a wire 702 engaged therewith, according to an example of the principles described herein. The example wire management clip 900 of FIGS. 9 and 10 is similar but not identical to the example wire management clip 800 described herein. The wire management clip 900 of FIG. 9 may include elements similar to or different from other examples described herein. The wire management clip 900 may include a retention body 902 with a c-shaped cross-section. The retention body 902 may include a first side 904-1 and a second side 904-2 coupled via a base 906 that together form the c-shaped cross-section. The first side 904-1, the second side 904-2, and the base 906 form a void 908 into which a return flange and/or a number of wires 702 may be seated.

The first side 904-1 may include a first channel 910-1 defined in the first side 904-1, and the second side 904-2 may include a second channel 910-2 defined in the second side 904-2. In one example, the first channel 910-1 and the second channel 910-2 may also be defined in at least a portion of the base 906. The first channel 910-1 and the second channel 910-2 may allow for at least a tooth 912 to be inserted therein. Although not shown, a second tooth may be inserted into the second channel 910-2 in a manner similar to other examples described herein. The tooth 912 may function in a similar manner as other teeth described herein by increasing a force against a wire and/or the return flange and increasing the coefficient of friction relative to the wire and/or the return flange and retain the wire and/or the return flange in the void 908. In one example, the tooth 912 may be made of a rubber material that has a relatively higher coefficient of friction than other materials to allow for the tooth 912 to secure the wire and/or the return flange as described herein.

The wire management clip 900 of FIG. 9 may further include a first set of protrusions 914-1 and a second set of protrusions 914-2. The first set of protrusions 914-1 and the second set of protrusions 914-2 may allow for any wires 702 inserted into the void 908 to be located at a back of the void 908 when placed past the second set of protrusions 914-2 towards the base 906 or located towards the front of the void 908 when placed between the first set of protrusions 914-1 and the second set of protrusions 914-2. This allows for the wires 702 that are inserted into to the void 908 to be compartmentalized or located at discrete portions within the void 908.

Further, the wire management clip 900 of FIG. 9 may include a first sloped face 916-1 and a second sloped face 916-2. The first sloped face 916-1 and the second sloped face 916-2 may be used to assist a user in engaging the wire management clip 900 with the return flange via the void 908 and/or assist the user in engaging the wire 702 within the void 908. In one example, the wire management clip 900 of FIG. 9 may be engaged with the return flange of the frame 206 via the void 908. In other words, the void 908 may be large enough to accommodate both the return flange of the frame 206 and at least one wire 702.

Like the example of FIGS. 6 through 8, in one example, the void 908 may be dimensioned to accommodate at least one wire 702. In this example, the wire management clip 900 may be coupled to the return flange of the frame 206 or other parts of the frame 206 via affixing the wire management clip 900 to the frame 206 via another means other than inserting the return flange of the frame 206 into the void 908. In this example, the wire management clip 900 may be glued to the frame 206 via the use of an adhesive, affixed to the frame 206 via a fastener or fastening device, or through other affixing means.

As depicted in FIG. 9, a wire 702 is depicted as being engaged in the wire management clip 900. The slack or extra length of the wire 702 may be pulled from the left or right as depicted in FIG. 9 to ensure that the wire 702 remains taut over a length of the wire 702 such that slack is taken up as the wire 702 may extend across a length of the one or more solar panel systems 200 within an array of solar panels. When the slack in the wire 702 is taken up, the tooth may become deformed. For example, the tooth 912 may be made of a rubber that allows for such deformation to take place. The deformation of the tooth prevents the wire 702 to be moved laterally through the wire management clip 900 in a direction opposite the direction the slack of the wire 702 was pulled through the wire management clip 900.

Despite the potential to insert the return flange into the void 808 along with the wire 702, in one example, the wire management clip 900 may further include a mounting channel 918 via which the wire management clip 900 may be coupled and secured to, for example, the return flange of the solar panel system 200 or other portions of the solar panel system 200. The mounting channel 918 may include the base 920, a first side 922-1, and a second side 922-2 defining the u-shaped void 924 in which the return flange may be seated. The above-described elements of the wire management clip 900 may have identical or similar features and functions of those similar elements described above in connection with the wire management clips of FIGS. 1 through 8.

Further, in one example, the wire management clip 900 of FIGS. 9 and 10 may include at least one tooth 138 in order to retain the coupling of the wire management clip 900 to the return flange, and may include a plurality of teeth 138 within the void 924 as depicted in, for example, FIG. 8. However, unlike the wire management clip 800 of FIG. 8, the wire management clip 900 of FIGS. 9 and 10 do not include teeth 138. In one example, however, the tooth 912 to be inserted into the first channel 910-1 described above may also extend a distance into the mounting channel 918 as well to provide the wire management clip 900 with the function and ability as described above in connection with the teeth of other examples.

In examples where teeth are not provided within the mounting channel 918, the mounting channel 918 may be dimensioned to allow for the return flange to be securely retained within the void 924 of the mounting channel 918 through a press fit or other interference fit. In this example, the inner surfaces of the first side 922-1 and the second side 922-2 of the mounting channel 918 may taper towards the base 920 to create an increase in force between the return flange and the mounting channel 918 within the void 924. A user may apply pressure to the wire management clip 900 as the return flange is inserted into the mounting channel 918 in order to obtain the press fit between the mounting channel 918 and the return flange. In one example, the material from which the mounting channel 918 is made may include a material that plastically or elastically deforms to allow for such press fit to occur. Further, in one example, as described above, the tooth 912 may include a t-shaped profile where the t-portion of the tooth 912 mounts within or seats on the through channel 928. Further, in this example, the t-portion of the tooth 912 may also serve to create a relatively higher coefficient of friction for instances when the mounting channel 918 is utilized to mount the wire management clip 900 onto a return flange of the frame 206.

The wire management clip 900 may include a through channel 928. The through channel 928 may be formed between the mounting channel 918 and into the retention body 902. The through channel 928 may also be formed in at least a portion of the base 906, the first side 904-1 and/or the first side 922-1 such that the tooth 912 may be inserted into the through channel 928 during manufacture or as the tooth 912 may wear or be replaced with a tooth 912 made of a different material such as rubber material with a different elasticity.

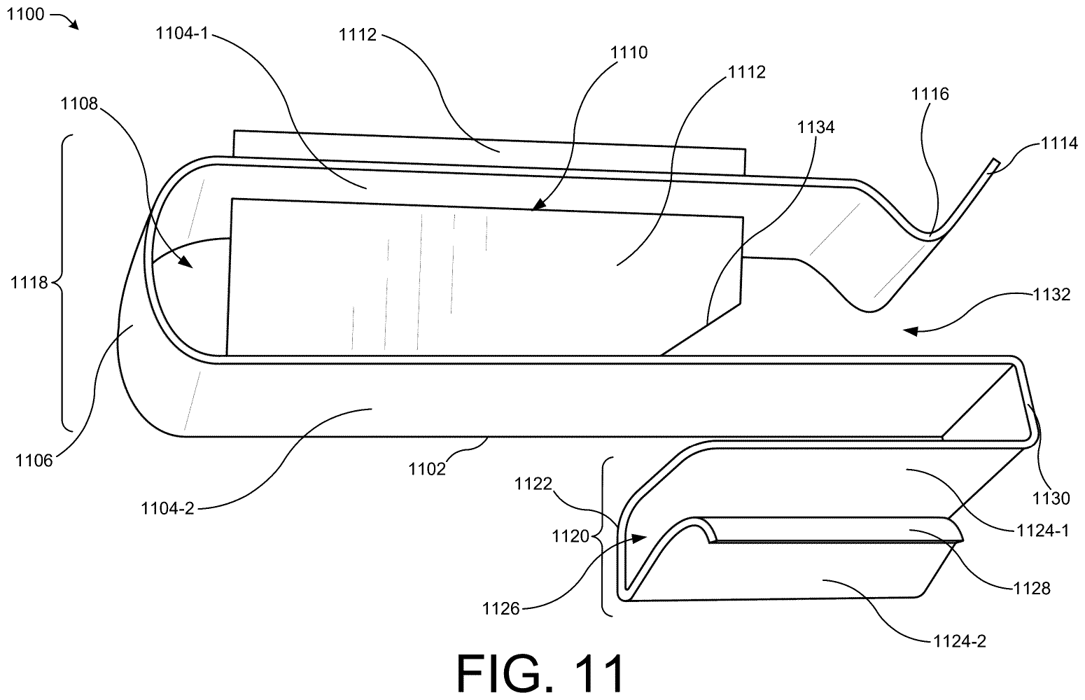

FIG. 11 illustrates a wire management clip 1100, according to an example of the principles described herein. The wire management clip 1100 of FIG. 11 may provide for the coupling of the wire management clip 1100 to a frame 206 of a solar panel system 200 as well as providing for the management of wires associated with the solar panel system 200. Further, the wire management clip 1100 of FIG. 11 may have relatively thinner walls. In this example, the wire management clip 1100 may be made of, for example, a metal that may be formed into various shapes and processed through heating, cooling, and other processes to create or maintain a spring bias throughout the wire management clip 1100. In one example where the wire management clip 1100 is made of metal, the various edges of the wire management clip 1100 may include up-turned or radiused edges that reduces or eliminates the possibility of wear on the wire(s) through, for example, scraping or chafing of the insulation or other layers of the wire(s).

The wire management clip 1100 may include a friction channel 1118 that may be used to secure wires, and a mounting channel 1120 that may be used to secure the wire management clip 1100 to a frame 206 of a solar panel system 200. The friction channel 1118 may be coupled to the mounting channel 1120 via a coupling arm 1130.

The friction channel 1118 may include a retention body 1102 including a first side 1104-1 and a second side 1104-2 coupled via a base 1106 that together form the c-shaped cross-section. The first side 1104-1, the second side 1104-2, and the base 1106 form a void 1108 into which a return flange and/or a number of wires 702 may be seated. The first side 1104-1 may include a channel 1110 defined in the first side 1104-1. The channel 1110 may allow for a tooth 1112 to be inserted therein. Although not shown, a second tooth may be inserted into a channel defined in the second side 1104-2 in a manner similar to other examples described herein. The tooth 1112 may function in a similar manner as other teeth described herein by increasing a force against a wire, increasing the coefficient of friction relative to the wire, and retain the wire in the void 1108. In one example, the tooth 1112 may be made of a rubber material that has a relatively higher coefficient of friction than other materials to allow for the tooth 1112 to secure the wire as described herein. In one example, the tooth 1112 may project through the channel 1110 an out to a top surface of the first side 1104-1. This may allow a user to physically adjust the degree to which the tooth 1112 extends into the void 1108 and the resultant force applied against a wire inserted into the void 1108 and engaged with the tooth 1112. Further, the tooth 1112 may project through the channel 1110 an out to a top surface of the first side 1104-1 in order to allow the user to replace the tooth 1112 in situations where the tooth 1112 may have worn or in situations where a tooth 1112 with different physical properties (e.g., a different elasticity) is to replace the tooth 1112. Further, in one example, the tooth 1112 may be formed via a metal stamping process where the tooth 1112 such as a barbed tooth may be formed. In this example, the tooth 1112 may be formed on the mounting channel 1120 such that the stamped tooth 1112 may engage with the return-flange.

Further, the wire management clip 1100 of FIG. 11 may include a sloped face 1114 and a retention protrusion 1116. The sloped face 1114 and the retention protrusion 1116 may be used to assist a user in guiding a wire to engage the wire through an opening 1132, into the void 1108 and in engagement with the tooth 1112. The retention protrusion 1116 may further assist in retaining the wire in the void 1108 before the wire is properly engaged with the tooth 1112. Further, the tooth 1112 may include a sloped face 1134 to help guide the wire into a lower portion of the tooth 1112 such that the wire is seated at a position along the width of the tooth 1112 where a maximum amount of force may be applied against the wire.

As similarly described above in connection with the examples of FIGS. 6 through 10 a wire 702 may be engaged in the wire management clip 1100, and a slack or extra length of the wire 702 may be pulled perpendicular to the tooth 1112 to ensure that the wire 702 remains taut over a length of the wire 702 and to ensure that the slack is taken up as the wire 702 may extend across a length of the one or more solar panels or one or more solar panel system 200. When the slack in the wire 702 is taken up, the tooth may become deformed. For example, the tooth 1112 may be made of a rubber that allows for such deformation to take place. The deformation of the tooth prevents the wire 702 to be moved perpendicularly to the tooth 1112 and through the wire management clip 1100 in a direction opposite the direction the slack of the wire 702 was pulled through the wire management clip 1100.

The wire management clip 1100 may further include a mounting channel 1120 via which the wire management clip 1100 may be coupled and secured to, for example, the return flange of the solar panel system 200 or other portions of the solar panel system 200. The mounting channel 1120 may include a base 1122, a first side 1124-1, and a second side 1124-2 defining the u-shaped void 1126 in which the return flange may be seated. The above-described elements of the wire management clip 1100 may have identical or similar features and functions of those similar elements described above in connection with the wire management clips of FIGS. 1 through 10. In one example, the base 1122, the first side 1124-1, and the second side 1124-2 may have a spring bias that resists expansion of the void 1126 and/or an increase in a distance between the first side 1124-1 and the second side 1124-2. In this manner, as the return flange is inserted into the void 1126, the spring bias of the mounting channel 1120 may ensure that the return flange is friction fit into the void 1126 and seated in the base 1122 and between the first side 1124-1 and the second side 1124-2 such that the return flange is secured within the void 1126.

In one example, the void created between the second side 1104-2 of the retention body 1102, the first side 1124-1 of the mounting channel 1120, and the coupling arm 1130 bridging the second side 1104-2 and the first side 1124-1 may also serve as a mounting channel with the coupling arm 1130 serving as the base. In this example, the wire management clip 1100 may be mounted to the return flange of the frame 206 in a parallel or perpendicular orientation with respect to the return flange. In one example, the void created by the second side 1104-2, the first side 1124-1, and the coupling arm 1130 may have similar characteristics and features of the friction channel 1118 and/or the mounting channel 1120.

In one example, the spring bias of the mounting channel 1120 may create a friction fit between the mounting channel 1120 and the return flange to ensure that the return flange may not easily move out of the mounting channel 1120 or move laterally along a length of the return flange as the return flange is seated within the mounting channel 1120. In order to insert the return flange into the void 1126 of the mounting channel 1120, a user may use force against a release appendage 1128 coupled to the second side 1124-2 to overcome this spring bias, expand of the void 1126, and/or an increase in a distance between the first side 1124-1 and the second side 1124-2. The user may then insert the return flange into the void 1126 of the mounting channel 1120 and remove the force applied to the release appendage 1128. Once the force applied to the release appendage 1128 is removed, the return flange may be secured in the mounting channel 1120 via the spring bias. In one example, the spring bias of the mounting channel 1120 may create a friction fit between the return flange and the base 1122, the first side 1124-1, and/or the second side 1124-2 such that the return flange is unable to move in any direction including out of the mounting channel 1120 or laterally along a length of the return flange as the return flange is seated within the mounting channel 1120 as described above. In order to remove the return flange from the mounting channel 1120, the user may again apply force to the release appendage 1128 to overcome the spring bias of the mounting channel 1120 and remove the return flange from inside the mounting channel 1120.

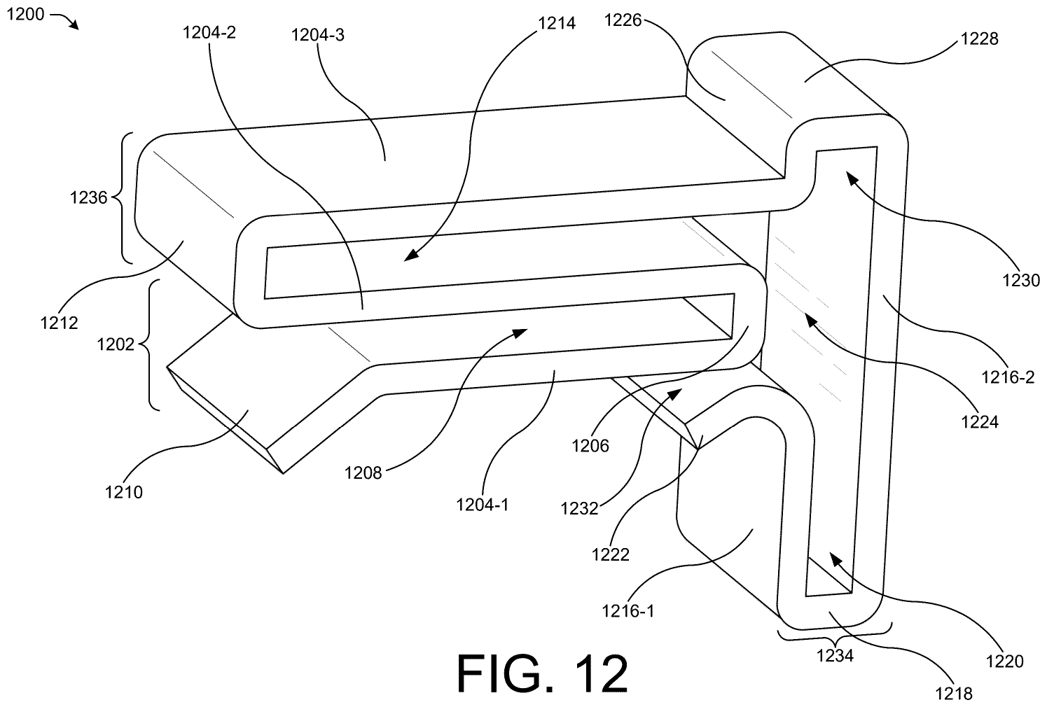

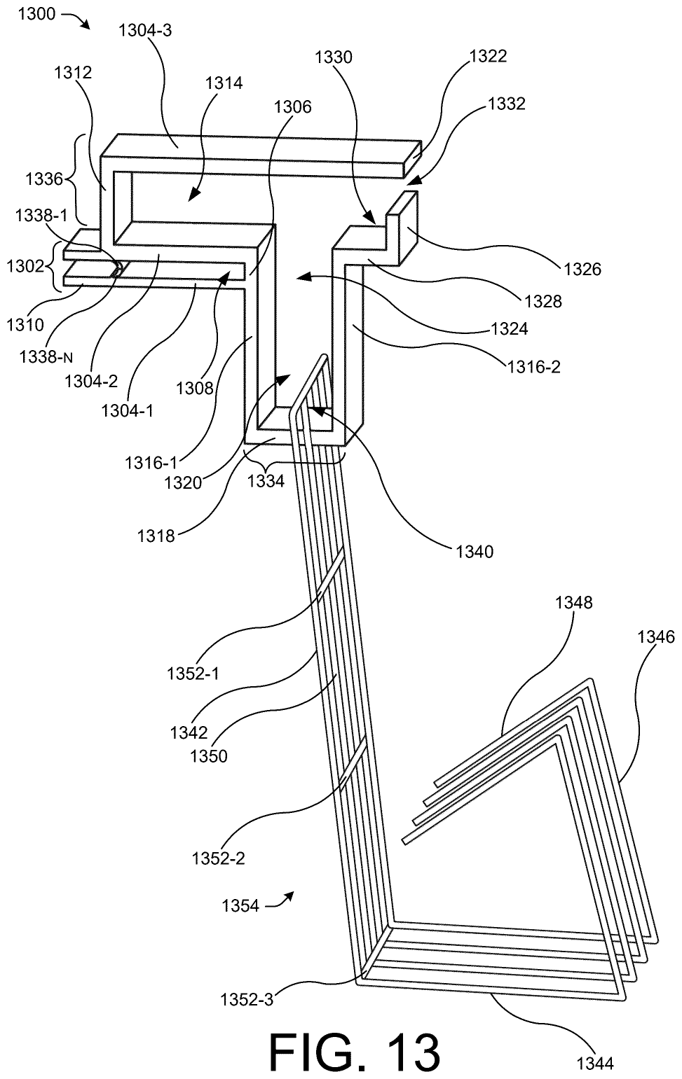

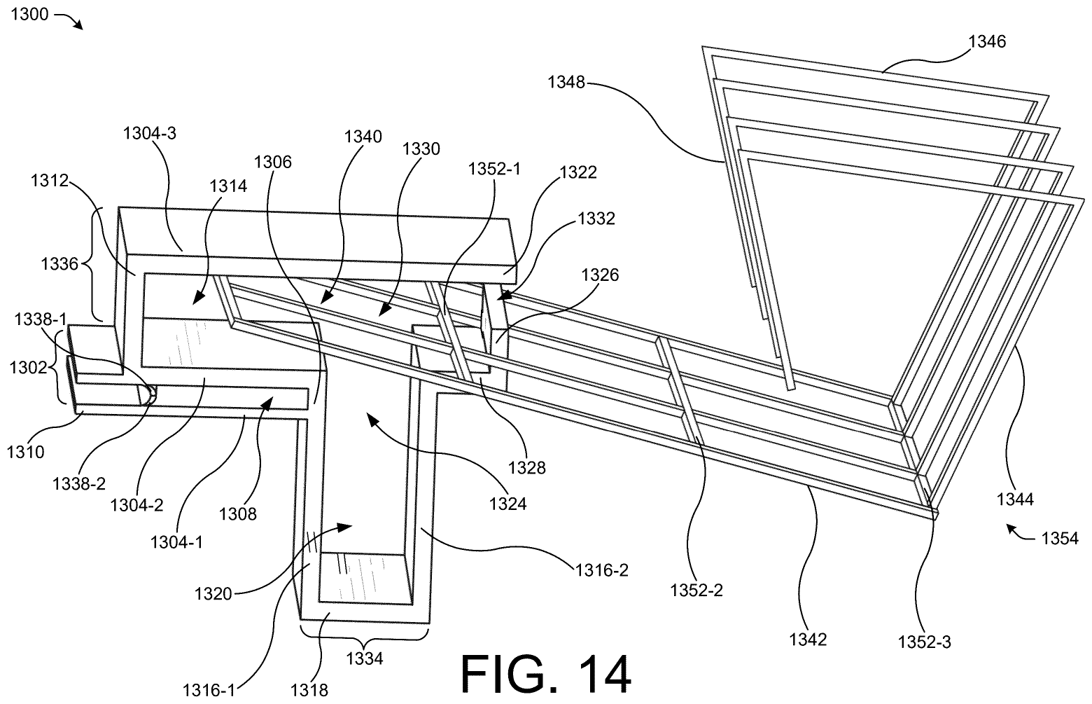

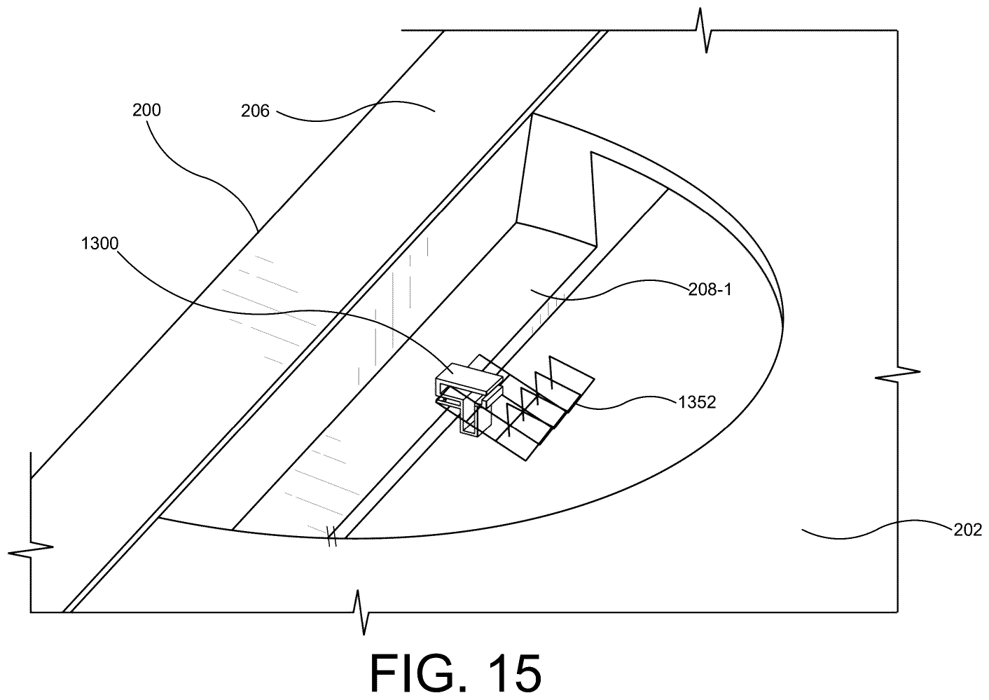

FIG. 12 illustrates a wire management clip 1200, according to an example of the principles described herein. FIG. 13 illustrates a wire management assembly 1300 including the wire management clip 1200 of FIG. 12 and an articulating support 1354 in a disengaged state with the wire management clip 1200, according to an example of the principles described herein. FIG. 14 illustrates the wire management assembly 1300 of FIG. 13 including the articulating support 1354 in an engaged state with the wire management clip 1200, according to an example of the principles described herein. FIG. 15 illustrates the wire management assembly 1300 of FIG. 13 in the engaged state and coupled to a frame 206, according to an example of the principles described herein.

The wire management clip 1200 may include a mounting channel 1202. The mounting channel 1202 may be used to couple the wire management clip 1200 to a return flange of the frame 206 of a solar panel system 200. The mounting channel 1202 may include a base 1206, a first side 1204-1, and a second side 1204-2 defining a u-shaped void 1208 in which the return flange may be seated. The above-described elements of the wire management clip 1200 may have identical or similar features and functions of those similar elements described above in connection with the wire management clips of FIGS. 1 through 11.

In one example where teeth are not provided within the mounting channel 1202, the mounting channel 1202 may be dimensioned to allow for the return flange to be securely retained within the void 1208 of the mounting channel 1202 through a press fit or other interference fit. In this example, the inner surfaces of the first side 1204-1 and the second side 1204-2 of the mounting channel 1202 may taper towards the base 1206 to create an increase in force between the return flange and the mounting channel 1202 within the void 1208. A user may apply pressure to the wire management clip 1200 as the return flange is inserted into the mounting channel 1202 in order to obtain the press fit between the mounting channel 1202 and the return flange. In one example, the material from which the mounting channel 1202 is made may include a material that plastically or elastically deforms to allow for such press fit to occur.

The wire management clip 1200 of FIG. 12 may further include a first sloped face 1210. The first sloped face 1210 may be used to assist a user in engaging the wire management clip 1200 with the return flange via the void 1208.

As depicted in FIGS. 12 through 15, an articulating support 1354 may be coupled to the wire management clip 1200 to form the wire management assembly 1300. Several portions of the wire management clip 1200 may be utilized to be coupled to the articulating support 1354 and position the articulating support 1354 within the wire management clip 1200 in a disengaged state as depicted in, for example, FIG. 13, or in an engaged state as depicted in, for example, FIGS. 14 and 15. The articulating support 1354 may include a number of wires coupled together to form a wire frame or lattice, and through which a portion of the wire management clip 1200 may be extended. In one example, the articulating support 1354 may be coupled to the wire management clip 1200 by inserting a portion of the articulating support 1354 into a main retention void 1224 via an opening 1232 as will be described in more detail below. In one example, the opening 1232 may be located below the mounting channel 1202 as depicted in FIG. 12. In one example, the opening 1232 may be located on an opposite side of the wire management clip 1200 relative to the mounting channel 1202 as depicted in, for example, FIGS. 13 through 15. A description of the wire management assembly 1300 of FIGS. 13 through 15 will be provided below, but there are similarities between both form and function of the wire management clip 1200 of FIG. 12 and the wire management assembly 1300 of FIGS. 13 through 15. The wire management clip 1200 of FIG. 12 may further include a second sloped face 1222. The second sloped face 1222 may be used to assist a user in engaging the articulating support 1354 with the wire management clip 1200 and into the void 1220 and other internal portions within the wire management clip 1200.

The example wire management clip 1200 of FIG. 12 may include a first position recess 1234 and a second position recess 1236 that allows the articulating support 1354 to be placed in a disengaged state and engaged state, respectively. The first position recess 1234 may be defined by a first side 1216-1, a second side 1216-2, and a base 1218 that defines a void 1220 in which a portion of the articulating support 1354 may be suspended or retained in a disengaged state as depicted in, for example, FIG. 13. The second position recess 1236 may be defined by the second side 1204-2 of the mounting channel 1202, a third side 1204-3, and a base 1212 that defines a void 1214 in which a portion of the articulating support 1354 may be suspended or retained in an engaged state as depicted in, for example, FIGS. 14 and 15.

Further, the wire management clip 1200 may include a side wall 1226, the second side 1216-2, and a base 1228 that defines a void 1230 in which a portion of the articulating support 1354 may enter in order to allow the articulating support 1354 to be adjusted between a disengaged state as depicted in, for example, FIG. 13 and an engaged state as depicted in, for example, FIGS. 14 and 15.

As depicted in FIGS. 13 through 15, the articulating support 1354 may include a first substate 1342, a second substrate 1344 coupled to the first substrate 1342 at an angle, a third substrate 1346 coupled to the second substrate 1344 at an angle, and a fourth substrate 1348 coupled to the third substrate 1346 at an angle such that the first substate 1342, the second substrate 1344, the third substrate 1346, and the fourth substrate 1348 create a basket or hook that may be used to secure bulk portions of wiring from the electrical module 204 of the solar panel system 200.

The first substate 1342, the second substrate 1344, the third substrate 1346, and the fourth substrate 1348 may include a plurality of rods 1350 such as a number of wires coupled together via a plurality of reinforcements 1352-1, 1352-2, 1352-N (where N is any integer greater than or equal to 1 (collectively referred to herein as reinforcement(s) 1352 unless specifically addressed otherwise)) running perpendicularly to the rods 1350 and coupled the rods 1350 to one another. Although the first substate 1342, the second substrate 1344, the third substrate 1346, and the fourth substrate 1348 of the articulating support 1354 is depicted as including the rods 1350 and the reinforcements 1352, any type of construction that forms the basket or hook form of the articulating support 1354 may be used.

The articulating support 1354 may include an aperture 1340 through which portions of the wire management clip 1200 may be extended. For example, the aperture 1340 may be fitted onto the wire management clip 1200 via the opening 1232. As noted above, the second sloped face 1222 may be used to assist a user in engaging the articulating support 1354 with the wire management clip 1200 and into the void 1220 and other internal portions within the wire management clip 1200. The articulating support 1354 may then be made to move about the main retention void 1224, the void 1220, the void 1230, and the void 1214 when moving the articulating support 1354 between the disengaged state depicted in FIG. 13 and the engaged state as depicted in FIGS. 14 and 15.

Turning to the example of the wire management assembly 1300 of FIG. 13, the wire management assembly 1300 may be similar in form and function as the example wire management clip 1200 of FIG. 12. The wire management assembly 1300 may include a mounting channel 1302. The mounting channel 1302 may be used to couple the wire management assembly 1300 to a return flange of the frame 206 of a solar panel system 200. The mounting channel 1302 may include a base 1306, a first side 1304-1, and a second side 1304-2 defining a u-shaped void 1308 in which the return flange may be seated. The above-described elements of the wire management assembly 1300 may have identical or similar features and functions of those similar elements described above in connection with the wire management clips of FIGS. 1 through 12.

Further, the mounting channel 1302 may further include at least one tooth, and, in the example of FIG. 13, the mounting channel 1302 may include a plurality of teeth 1338-1, . . . 1338-N (where N is any integer greater than or equal to 1 (collectively referred to herein as teeth 1338 unless specifically addressed otherwise)). Like in other examples described herein, the teeth 1338 may be angled into the void 1308 and toward an interior of the void 1308 such as toward the base 1306 in order to provide for an easy push-connection that allows for the wire management assembly 1300 to be relatively easier to engage with the return flange and that is relatively harder to disengage from the return flange. The teeth 1338 of the example of FIG. 13 may be couped to the first side 1304-1 and/or the second side 1304-2 and to an interior portion of the void 1308. The teeth 1338 may be coupled to the mounting channel 1302 via a plurality of socket apertures 140 such as those described above in connection with FIGS. 1 through 5 or may be monolithically formed with the mounting channel 1302. Thus, the wire management assembly 1300 of FIG. 13 may include a plurality of teeth 1338 to further secure the wire management assembly 1300 to the return flange of the frame 206 through additional or increased friction created between the teeth 1338 and the return flange. Further, as mentioned above, the plurality of teeth 1338 may be located within the mounting channel 130 on both the first side 1304-1 and the second side 1304-2 such that the plurality of teeth 1338 oppose one another to even further increase the coefficient of friction through the application of additional force against the return flange.

The wire management assembly 1300 of FIG. 13 may further include a first sloped face 1310 that may be used to assist a user in engaging the wire management assembly 1300 with the return flange via the void 1308. Although the first sloped face 1310 is not depicted in FIG. 13 as having a defined slope, the first sloped face 1310 may be similar to the first sloped face 1210 depicted in connection with the wire management clip 1200 of FIG. 12.

As depicted in FIGS. 13 through 15, the articulating support 1354 may be coupled to the wire management assembly 1300 to form the wire management assembly 1300. Several portions of the wire management assembly 1300 may be utilized to be coupled to the articulating support 1354 and position the articulating support 1354 within the wire management assembly 1300 in a disengaged state as depicted in, for example, FIG. 13, or in an engaged state as depicted in, for example, FIGS. 14 and 15. The articulating support 1354 may include a number of wires coupled together to form a wire frame or lattice, and through which a portion of the wire management assembly 1300 may be extended. In one example, the articulating support 1354 may be coupled to the wire management assembly 1300 by inserting a portion of the articulating support 1354 into a main retention void 1324 via an opening 1332 as will be described in more detail below. It is noted here that the opening 1332 through which the articulating support 1354 may be coupled to the wire management assembly 1300 is located on an opposite side relative to the opening 1232 depicted in FIG. 12. However, the location of the opening 1332 may be anywhere along the exterior of the wire management assembly 1300. The wire management assembly 1300 of FIG. 13 may further include a second sloped face 1322. Although the second sloped face 1322 is not depicted in FIG. 13 as having a defined slope, the second sloped face 1322 may be similar to the second sloped face 1222 depicted in connection with the wire management clip 1200 of FIG. 12. The second sloped face 1322 may be used to assist a user in engaging the articulating support 1354 with the wire management assembly 1300 and into the void 1320 and other internal portions within the wire management assembly 1300.

The example wire management assembly 1300 of FIG. 13 may include a first position recess 1334 and a second position recess 1336 that allows the articulating support 1354 to be placed in a disengaged state and engaged state, respectively. The first position recess 1334 may be defined by a first side 1316-1, a second side 1316-2, and a base 1318 that defines a void 1320 in which a portion of the articulating support 1354 may be suspended or retained in a disengaged state as depicted in, for example, FIG. 13. The second position recess 1336 may be defined by the second side 1304-2 of the mounting channel 1302, a third side 1304-3, and a base 1312 that defines a void 1314 in which a portion of the articulating support 1354 may be suspended or retained in an engaged state as depicted in, for example, FIGS. 14 and 15.

Further, the wire management assembly 1300 may include a side wall 1326, the second side 1316-2, and a base 1328 that defines a void 1330 in which a portion of the articulating support 1354 may enter in order to allow the articulating support 1354 to be adjusted between a disengaged state as depicted in, for example, FIG. 13 and an engaged state as depicted in, for example, FIGS. 14 and 15. Further, as depicted in FIG. 14, the base 1328 may support and/or retain a reinforcement 1352 of the articulating support 1354 within the void 1330 when the articulating support 1354 is adjusted to the engaged state.

The articulating support 1354 may include an aperture 1340 through which portions of the wire management assembly 1300 may be extended. For example, the aperture 1340 may be fitted onto the wire management assembly 1300 via the opening 1332. As noted above, the second sloped face 1322 may be used to assist a user in engaging the articulating support 1354 with the wire management assembly 1300 and into the void 1320 and other internal portions within the wire management assembly 1300. The articulating support 1354 may then be made to move about the main retention void 1324, the void 1320, the void 1330, and the void 1314 when moving the articulating support 1354 between the disengaged state depicted in FIG. 13 and the engaged state as depicted in FIGS. 14 and 15.

Turning to FIGS. 14 and 15, the wire management assembly 1300 and the articulating support 1354 are depicted in an engaged state, and, in FIG. 15, the wire management assembly 1300 is coupled to the first portion 208-1 of the frame 206 of the solar panel system 200. As depicted in FIG. 15, the wire management assembly 1300, like other examples of the wire management clip described herein, may be coupled to the frame 206 underneath the solar panel system 200 where the wires may be secured and managed by the wire management assembly 1300. This, in turn, ensures that the wires does not extend past framing 206 of the solar panel system 200, come into contact with the mounting surface, become exposed from an underneath portion of the solar panel arrays, and/or become exposed to sunlight, precipitation, wind, and other types of environmental forces that may compromise the integrity of the wiring as a mechanical load bearing device, electric current carrier, and/or a telecommunication signals transmission device.

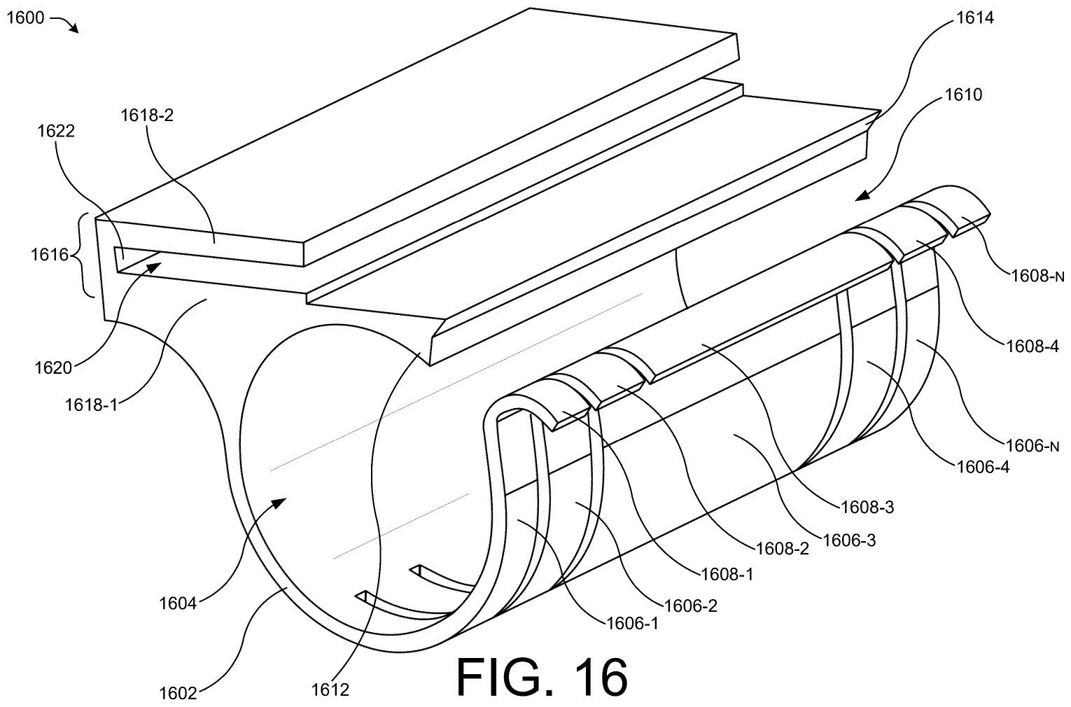

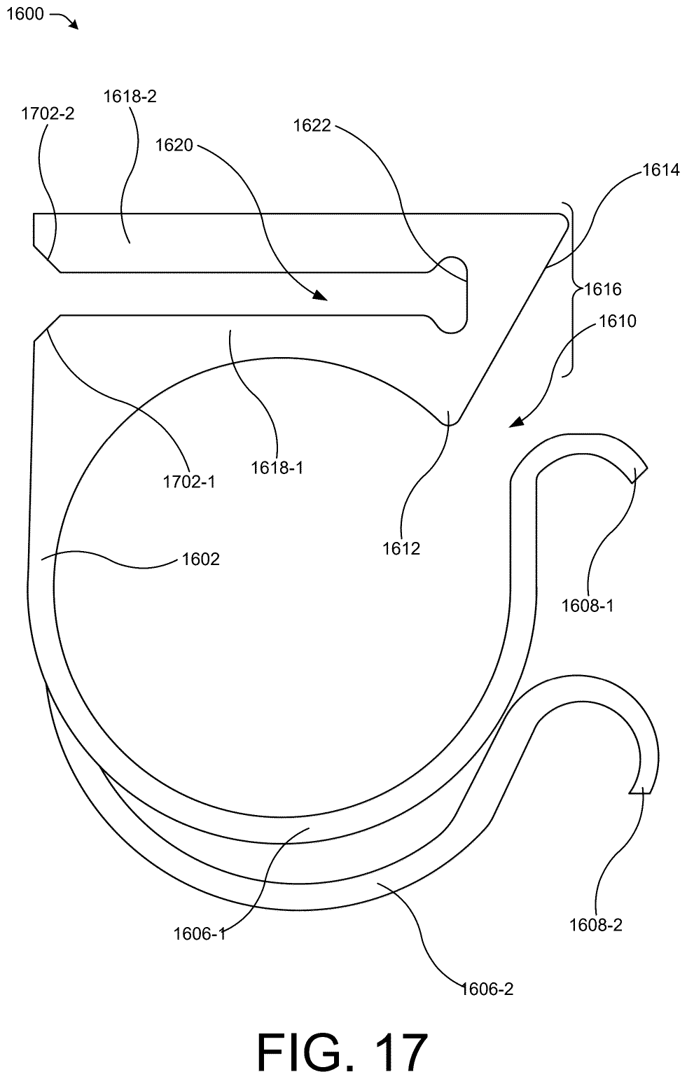

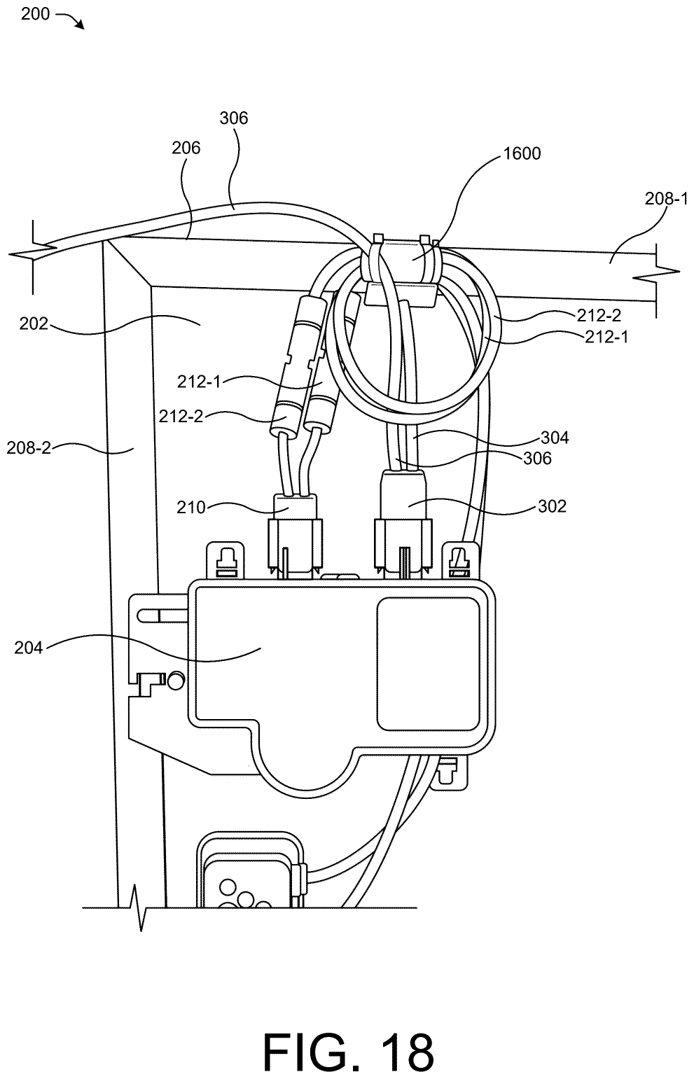

FIG. 16 illustrates a perspective view of a wire management clip 1600, according to an example of the principles described herein. FIG. 17 illustrates a side view of the wire management clip 1600 of FIG. 16, according to an example of the principles described herein. FIG. 18 illustrates the wire management clip 1600 of FIG. 16 with wires engaged therewith and coupled to a frame 206, according to an example of the principles described herein.

The wire management clip 1600 of FIG. 16 may include a retention body 1602 that may serve as a main portion of the wire management clip 1600 that may retain, for example, wiring (e.g., the first wire 212-1, the second wire 212-2, the input wire 304, the output wire 306) of a wire harness (e.g., the first wire harness 210, the second wire harness 302) coupled to the electrical module 204 or other bulk portions of wiring. The retention body 1602 may have a c-shaped, circular, or semi-circular cross-section, and a void 1604 formed to allow the bulk wiring to be seated within the retention body 1602. Further, the c-shaped cross-section of the retention body 1602 may include an opening 1610 through which the bulk wiring may be inserted into the void 1604 of the retention body 1602 and seated therein. The opening 1610 may have a terminus 1612.

Further, the c-shaped cross-section of the retention body 1602 may terminate at an end opposite the terminus 1612 with a plurality of displaceable arms 1606-1, 1606-2, 1606-3, 1606-4, . . . 1606-N (where N is any integer greater than or equal to 1 (collectively referred to herein as displaceable arm(s) 1606 unless specifically addressed otherwise)). The displaceable arms 1606 may be used to secure any wires associated with the solar panel system 200 such as, for example, the input wire 304 and the output wire 306 of the second wire harness 302 coupled to the electrical module 204. However, in one example, the displaceable arms 1606 may be used to secure any of the wiring (e.g., the first wire 212-1, the second wire 212-2) of the first wire harness 210 coupled to the electrical module 204.

In one example, the c-shaped cross-section of the retention body 1602 may have a spring bias that resists expansion of the c-shaped cross-section, resists an increase in the size of the opening 1610, and/or resists an increase in the distance between the terminus 1612 and the displaceable arms 1606. For example, the displaceable arms 1606 may include this spring bias such that each individual displaceable arm 1606 may be displaceable with respect to one another and with respect to the remainder of the retention body 1602. In this manner, as weight increases with the insertion of the bulk wiring into the void 1604 of the retention body 1602, the spring bias of the c-shaped cross-section of the retention body 1602 and the displaceable arms 1606 may ensure that the shape of the c-shaped cross-section resists expansion. In order to insert the bulk wiring into the void 1604 of the retention body 1602, a user may use force to overcome this spring bias and expand the c-shaped cross-section, increase in the size of the opening 1610, increase in a distance between the terminus 1612 and the displaceable arms 1606, and/or displace one or more of the displaceable arms 1606. More regarding the insertion and retention of the bulk wiring into the void 1604 of the retention body 1602 and the utilization of individual displaceable arms 1606 is described herein. Although the wire management clip 1600 of FIG. 16 is not depicted as including a friction channel to retain a wire therein, the wire management clip 1600 may include a friction channel such as those described herein in connection with the examples of FIGS. 1 through 5. The terminus 1612 may include a sloped face 1614. The sloped face 1614 may be used to assist a user in engaging bulk wiring within the void 1604 of the retention body 1602 and seated therein.

The displaceable arms 1606 described in connection with the embodiments presented herein may be used to not only retain a wire therein, but also to apply friction to the wire and allow the wire to be made taut over a length of the wire such that slack is taken up as the wire may extend across a length of the one or more solar panel arrays. The reason wiring may need to be retained and slack taken up along the length of the wire is to ensure that the wire does not extend past framing of the solar panel arrays, come into contact with the mounting surface, become exposed from an underneath portion of the solar panel arrays, and/or become exposed to sunlight, precipitation, wind, and other types of environmental forces that may compromise the integrity of the wiring as a mechanical load bearing device, electric current carrier, and/or a telecommunication signals transmission device.

In the example of FIG. 16, the displaceable arms 1606 of the wire management clip 1600 may form part of the retention body 1602 and may be monolithically formed with the retention body 1602 as depicted in FIGS. 16 through 18. The displaceable arms 1606 may be individually displaced with respect to one another as depicted in FIGS. 17 and 18 to allow for a wire to be placed between the interior surface of a displaceable arm 1606 that has been displaced from the other displaceable arms 1606, and the exterior surfaces of the displaceable arms 1606 that are not displaced.

The spring bias of each of the displaceable arms 1606 may be used to secure the wires. The displaceable arms 1606 may each include a release appendage 1608-1, 1608-2, 1608-3, 1608-4, 1608-N (where N is any integer greater than or equal to 1 (collectively referred to herein as release appendage(s) 1608 unless specifically addressed otherwise)) extending from the displaceable arms 1606. The release appendages 1608 may be used by a user to assist the use to overcome the spring bias as described herein.

As depicted in FIGS. 17 and 18, in order to insert the wire in between the displaceable arms 1606, a user may use force against the release appendages 1608 to overcome this spring bias and displace a displaceable arm 1606 with respect to the other displaceable arms 1606 to create a void between the displaceable arms 1606. In FIGS. 17 and 18, the second displaceable arm 1606-2 is depicted as displaced in this manner. The user may then insert the wire into the void formed between the second displaceable arm 1606-2, and the first displaceable arm 1606-1 and the third displaceable arm 1606-3. The second displaceable arm 1606-2 is depicted as being displaced, but any of the displaceable arms 1606 may be utilized in this manner. Once the wire has been placed between the second displaceable arm 1606-2, and the first displaceable arm 1606-1 and the third displaceable arm 1606-3 and the user removes the force applied to the release appendages 1608. Once the force applied to the release appendages 1608 is removed, the wire may be secured between the second displaceable arm 1606-2, and the first displaceable arm 1606-1 and the third displaceable arm 1606-3 via the spring bias. In one example, the spring bias of the displaceable arms 1606 may create a friction fit between the wire and the displaceable arms 1606 such that the wire is unable to move in any direction including out of between the displaceable arms 1606 or laterally along a length of the wire as the wire is seated within the displaceable arms 1606 as described above. In order to remove the wire from between the displaceable arms 1606, the user may again apply force to the release appendages 1608 to overcome the spring bias and remove the wire from between the displaceable arms 1606. The spring bias of the displaceable arms 1606 may ensure that slack of the wire may be taken up and the wire may be secured at a desire point along the length of the wire within the displaceable arms 1606.

In one example, the displaceable arms 1606 may be displaced at any degree to fit types of wires where the wires have different characteristics, features, or purposes. For example, the displaceable arms 1606 may be displaced and/or configured to fit different gauges of wires. Further, in one example, the displaceable arms 1606 may be dimensioned and/or configured to fit wires that are to be run along a length of the solar panel system 200 in different directions and/or to devices within the solar panel system 200 that serve different purposes or functions.

In one example, the displaceable arms 1606 may have varying lengths. For example, the third displaceable arm 1606-3 may have a relatively longer length with respect to the first displaceable arm 1606-1, the second displaceable arm 1606-2, the fourth displaceable arm 1606-4, and/or the fifth displaceable arm 1606-N. With the relatively longer length of the third displaceable arm 1606-3, the third displaceable arm 1606-3 may have a relatively higher spring bias then the remainder of the displaceable arms 1606 due to the relatively larger mass of the third displaceable arm 1606-3. The relatively higher spring bias of the third displaceable arm 1606-3 may allow for the third displaceable arm 1606-3 to serve as a buttress or reinforcement against with the wire may be pressed against by the remainder of the displaceable arms 1606. Further, in one example, the displaceable arms 1606 may have different spring biases and/or may be made of different materials in order to allow for the displaceable arms 1606 to provide different forces between the displaceable arms 1606.

The wire management clip 1600 may further include a mounting channel 1616 via which the wire management clip 1600 may be coupled and secured to, for example, a return flange of the solar panel system 200 or other portions of the solar panel system 200 as described herein. The mounting channel 1616 may engage with the return flange of the frame of the solar panel system 200 and withstand removal from the return flange. The mounting channel 1616 may have an opening in any side of the wire management clip 1600 such as a first side a depicted in FIG. 16 and a second side as depicted in FIG. 17.

As depicted in FIGS. 16 and 17, for example, the mounting channel 1616 may include a base 1622, a first side 1618-1, and a second side 1618-2 defining a generally u-shaped void 1620 in which the return flange may be seated. In one example, portions of the base 1622 and/or the first side 1618-1 may form part of the retention body 1602 and may be monolithically formed together as depicted in FIGS. 16 and 17.

The void 1620 of the mounting channel 1616 may be dimensioned and/or configured to couple with the return flange such that insertion of the return flange into the void 1620 may secure the wire management clip 1600 to the return flange via a friction fit or other type of interference fit. In one example, the base 1622 may include a shape that may match an end of the return flange. For example, as depicted in FIG. 17, the base 1622 may include a semicircular shape that may match a blunted end of the return flange to allow of the return flange to more tightly engage with the base 1622. Further, in one example, the base 1622 may include a semi-circular or oval shape that serves as a strain relief within the mounting channel 1616 to accommodate for a relatively larger thickness of a return flange to which the mounting channel 1616 is to interface.

Further, in order to retain the coupling of the wire management clip 1600 to the return flange, at least one tooth may be included within the void 1620 of the mounting channel 1616 as depicted and included in other examples described herein.

The first side 1618-1 and the second side 1618-2 of the mounting channel 1616 may include a first sloped face 1702-1 and a second sloped face 1702-2 that may be used to assist a user in engaging the wire management clip 1600 with the return flange via the mounting channel 1616. As a user seeks to couple the wire management clip 1600 to the return flange, the user may utilize the first sloped face 1702-1 and the second sloped face 1702-2 to locate the opening of the mounting channel 1616 and guide the return flange into the mounting channel 1616.

In relation to FIGS. 16 and 17, FIG. 18 illustrates the wire management clip 1600 of FIGS. 16 and 17 in use in connection with an electrical module 204 and a frame 206 with first wiring (e.g., the first wire 212-1 and the second wire 212-2 of the first wire harness 210) of the electrical module 204 being retained in a retention body 1602 of the wire management clip 1600, according to an example of the principles described herein. FIG. 18 further illustrates the wire management clip 1600 of FIG. 16 in use in connection with the electrical module 204 and the frame 206 with slack of the second wiring (e.g., the input wire 304 and the output wire 306 of the second wire harness 302) being taken up in a displaceable arms 1606 of the wire management clip 1600, according to an example of the principles described herein. The wire management clip 1600 may be coupled to the frame 206 at a first portion 208-1 or a second portion 208-2 of the frame 206 via the mounting channel 1616. Thus, in FIG. 18, the mounting channel 1616 is not shown, but the retention body 1602, the and the displaceable arms 1606 are depicted.

The wire management clip 1600 may be coupled to a first portion 208-1 of the frame 206. Further, the electrical module 204 may be coupled to a second portion 208-2 of the frame 206. The electrical module 204 may include any electrical module electrically coupled to the solar panel 202 such as an electrical junction box, a power optimizer, or similar electrical device as mentioned above. The electrical module 204 may be electrically coupled to the solar panel 202 and other solar panels 202 in an overall system via a first wire harness 210. The first wire harness 210 may be coupled to the electrical module 204 and may include a first wire 212-1 and a second wire 212-2 extending therefrom. In one example, the first wire 212-1 and the second wire 212-2 may be directly coupled between the electrical module 204 and the solar panel 202.

The first wire 212-1 and the second wire 212-2 may be coupled to the electrical module 204 and may include more length of wire than may be required. As depicted in FIGS. 2 through 4, the first wire 212-1 and the second wire 212-2 may be coiled up and secured in the retention body 1602 of the wire management clip 1600. This ensures that the first wire 212-1 and the second wire 212-2 are secured to, for example, the first portion 208-1 (or second portion 208-2) of the frame 206 and keeps the first wire 212-1 and the second wire 212-2 organized underneath the solar panel system 200. Further, coupling the first wire 212-1 and the second wire 212-2 to the solar panel system 200 in this manner keeps the first wire 212-1 and the second wire 212-2 out of contact with a mounting surface on which the solar panel system 200 is mounted and ensures that environmental forces do not negatively affect the function and integrity of the first wire 212-1 and the second wire 212-2.

Further, as depicted in FIG. 18, the electrical module 204 may further include a second wire harness 302 coupled to the electrical module 204. The second wire harness 302 may, in turn, be coupled to an input wire 304 and an output wire 306. The input wire 304 may include a wire coupled to the electrical module 204 from a second solar panel system 200 that is electrically upstream from the solar panel system 200. Further, the output wire 306 may include a wire coupled to a solar panel system 200 that is electrically downstream from the electrical module 204 of the solar panel system 200. Since the input wire 304 and the output wire 306 extend to additional solar panel arrays, the length of the input wire 304 and/or the output wire 306 may vary, and during installation the wires may be cut to a length or may be manufactured at a length that is longer than required for the installation of a series of solar panel arrays. Because the length of the input wire 304 and/or the output wire 306 may be longer, the input wire 304 and the output wire 306 may be coupled between the displaceable arms 1606 as depicted in FIG. 18 in connection with the output wire 306 being secured between the second displaceable arm 1606-2, and the first displaceable arm 1606-1 and the third displaceable arm 1606-3.

As to the output wire 306, coupling the output wire 306 between the second displaceable arm 1606-2, and the first displaceable arm 1606-1 and the third displaceable arm 1606-3 may include initially coupling the output wire 306 such that any slack in the output wire 306 is taken up and pulled through the void between the second displaceable arm 1606-2, and the first displaceable arm 1606-1 and the third displaceable arm 1606-3 to ensure that no slack is present between the second wire harness 302 and the wire management clip 1600. Since the output wire 306 serves as an input wire 304 for a solar panel system 200 electrically downstream from the solar panel system 200 depicted in FIG. 18, any additional length or slack that may exist in the output wire 306 may be addressed at that electrically downstream solar panel system 200 as described above in connection with the input wire 304. In one example, the void formed between the fourth displaceable arm 1606-4, and the third displaceable arm 1606-3 and the third displaceable arm 1606-N may serve as an anchor that may allow for the slack of the output wire 306 to be taken up at the subsequent solar panel system 200 were a second wire management clip 1600 may similarly be installed and provide the functionality as described above. In this manner, the output wire 306 may be kept out of contact with a mounting surface on which the solar panel system 200 is mounted and ensures that environmental forces do not negatively affect the function and integrity of the output wire 306. Any number of wire management clips 1600 may be attached at any position along the length of the first portion 208-1 and/or the second portion 208-2 of the frame 206 to provide additional support for the first wire 212-1, the second wire 212-2, the input wire 304, and/or the output wire 306 as described above.

Notably, each of the examples of wire management clips described herein may include any elements of other examples of wire management clips. Further, the wire management clips may have any sizes or dimensions to accommodate for any number of wires.

### CONCLUSION

While the present systems and methods are described with respect to the specific examples, it is to be understood that the scope of the present systems and methods are not limited to these specific examples. Since other modifications and changes varied to fit particular operating requirements and environments will be apparent to those skilled in the art, the present systems and methods are not considered limited to the example chosen for purposes of disclosure and covers all changes and modifications which do not constitute departures from the true spirit and scope of the present systems and methods.

Although the application describes examples having specific structural features and/or methodological acts, it is to be understood that the claims are not necessarily limited to the specific features or acts described. Rather, the specific features and acts are merely illustrative of some examples that fall within the scope of the claims of the application.

What is claimed is:

1. A wire management clip comprising:
a retention body;
a friction channel formed on and extending from the retention body; and
a mounting channel formed on the retention body.

2. The wire management clip of claim 1, wherein the retention body includes:
a c-shaped body having an opening configured to retain a cable;
a first terminus of the c-shaped body; and
a second terminus of the c-shaped body.

3. The wire management clip of claim 2, wherein the c-shaped body includes a spring bias creating a static state between the first terminus and the second terminus and restricts movement of the first terminus and the second terminus relative to one another.

4. The wire management clip of claim 1, wherein the friction channel includes a plurality of frictions channels formed on and extending from a corresponding number of portions of the retention body.

5. The wire management clip of claim 1, wherein the friction channel includes a u-shaped body including:
a first leg extending from the retention body;
a second leg formed by the retention body; and
an opening configured to secure a cable.

6. The wire management clip of claim 5, wherein the friction channel further includes a release tab extending from the first leg.

7. The wire management clip of claim 1, wherein the mounting channel includes:
a first leg extending from the retention body; and
a second leg formed by the retention body,
wherein a distance between the first leg and the second leg is based at least in part on a thickness of a flange to which the wire management clip is coupled.

8. The wire management clip of claim 7, wherein the mounting channel further includes a friction retention device to retain the mounting channel of the wire management clip to the flange.

9. The wire management clip of claim 8, wherein the friction retention device has a coefficient of friction greater than the flange.

10. The wire management clip of claim 8, wherein the friction retention device includes a tooth angled with respect to the first leg or the second leg.

11. The wire management clip of claim 10, wherein the tooth includes a rubber material.

12. The wire management clip of claim 11, wherein the rubber material is co-extruded with a material of the wire management clip.

13. The wire management clip of claim 10, wherein the tooth includes a plurality of teeth.

14. The wire management clip of claim 13, wherein the plurality of teeth includes:
a first tooth extending from the first leg; and
a second tooth extending from the second leg.

15. The wire management clip of claim 10, wherein the tooth is angled within the mounting channel in a direction to towards an interior of the mounting channel such that the wire management clip resists removal from the flange.

16. A wire management clip comprising:
a retention body having a c-shaped body with an opening sized to retain a cable;
a friction channel formed on and extending from the retention body; and
a mounting channel formed on the retention body including a friction retention device to retain the mounting channel of the wire management clip to a flange.

17. The wire management clip of claim 16, wherein the retention body further includes:
a first terminus of the c-shaped body; and
a second terminus of the c-shaped body,
wherein the c-shaped body includes a spring bias forcing the first terminus toward the second terminus.

18. The wire management clip of claim 16, wherein:
the friction retention device has a coefficient of friction greater than the flange, and
the friction retention device is co-extruded with the wire management clip, the friction retention device being made of first material and the wire management clip being made of a second material different from the first material.

19. The wire management clip of claim 18, wherein the friction retention device is angled within the mounting channel in a direction to towards an interior of the mounting channel such that the wire management clip resists removal from the flange.

20. The wire management clip of claim 16, wherein the friction channel has a u-shaped body including:
a first leg extending from the retention body;
a second leg formed by the retention body;
an opening defined in the friction channel configured to secure the cable; and
a release tab extending from the first leg.
